(19) United States
(12) Patent Application Publication
(10) Pub. No.: US 2025/0013103 A1
(43) Pub. Date: Jan. 9, 2025

(54) LIQUID CRYSTAL DIFFRACTION ELEMENT, OPTICAL ELEMENT, IMAGE DISPLAY UNIT, HEAD-MOUNTED DISPLAY, BEAM STEERING, AND SENSOR

(71) Applicant: FUJIFILM Corporation, Tokyo (JP)

(72) Inventors: Shunya KATOH, Minamiashigara-shi (JP); Harue INAGAKI, Minamiashigara-shi (JP)

(73) Assignee: FUJIFILM Corporation, Tokyo (JP)

(21) Appl. No.: 18/886,707

(22) Filed: Sep. 16, 2024

Related U.S. Application Data
(63) Continuation of application No. PCT/JP2023/011089, filed on Mar. 22, 2023.

(30) Foreign Application Priority Data
Mar. 29, 2022 (JP) 2022-053856

(51) Int. Cl. G02F 1/1337; C09K 19/04; C09K 19/58; G01S 7/481; G02B 27/01; G02F 1/1335

(52) U.S. Cl. CPC G02F 1/133757; C09K 19/04; C09K 19/586; G02F 1/133541; G02F 1/133711; G02F 1/133788; C09K 2019/0448; G01S 7/4816; G02B 27/0172

(57) ABSTRACT

Provided are a liquid crystal diffraction element having a small angle dependence of diffraction efficiency and excellent heat resistance, and a liquid crystal diffraction element, an optical element, an image display unit, a head-mounted display, a beam steering, and a sensor that include the liquid crystal diffraction element. A liquid crystal diffraction element according to the present invention includes an optically-anisotropic layer that is formed of a liquid crystal composition including a polymerizable liquid crystal compound, in which the polymerizable liquid crystal compound includes at least one monofunctional polymerizable liquid crystal compound having one polymerizable group, the optically-anisotropic layer has a liquid crystal alignment pattern in which an orientation of an optical axis derived from the monofunctional polymerizable liquid crystal compound changes while continuously rotating in at least one in-plane direction, and in an infrared absorbance spectrum where a measurement sample obtained by powdering the optically-anisotropic layer is measured by Fourier transform infrared spectroscopy, an area ratio of a specific peak satisfies a predetermined relational expression.

### CROSS-REFERENCE TO RELATED APPLICATIONS

This application is a Continuation of PCT International Application No. PCT/JP2023/011089 filed on Mar. 22, 2023, which claims priority under 35 U.S.C. § 119(a) to Japanese Patent Application No. 2022-053856 filed on Mar. 29, 2022. The above applications are hereby expressly incorporated by reference, in their entirety, into the present application.

### BACKGROUND OF THE INVENTION

### 1. Field of the Invention

The present invention relates to a liquid crystal diffraction element, an optical element, an image display unit, a head-mounted display, a beam steering, and a sensor.

### 2. Description of the Related Art

The liquid crystal diffraction element is an element that diffracts incidence light and allows transmission of the diffracted light, and a liquid crystal diffraction element including an optically-anisotropic layer that is formed of a liquid crystal composition including a liquid crystal compound is known.

For example, WO2021/200228A describes a liquid crystal diffraction element that is formed of a liquid crystal composition including a liquid crystal compound and has a liquid crystal alignment pattern in which an orientation of an optical axis derived from the liquid crystal compound changes while continuously rotating in at least one in-plane direction.

### SUMMARY OF THE INVENTION

As a result of investigating the liquid crystal diffraction element described in WO2021/200228A, the present inventors have found that, depending on components of the liquid crystal composition, a difference (hereinafter, also referred to as “angle dependence of diffraction efficiency”) between a diffraction efficiency of emitted (transmitted) light in a case where light is incident from the front (direction in which an angle with respect to a normal line is 0°) and a diffraction efficiency of emitted (transmitted) light in a case where light is incident from an oblique direction (direction in which an angle with respect to the normal line is 20°) may increase, and heat resistance may also deteriorate.

Accordingly, an object of the present invention is to provide a liquid crystal diffraction element having a small angle dependence of diffraction efficiency and excellent heat resistance, and a liquid crystal diffraction element, an optical element, an image display unit, a head-mounted display, a beam steering, and a sensor that include the liquid crystal diffraction element.

As a result of conducting a thorough investigation to achieve the above-described object, the present inventors found that, in a liquid crystal diffraction element including an optically-anisotropic layer that is formed of the liquid crystal composition including at least one monofunctional polymerizable liquid crystal compound having one polymerizable group and where, in an infrared absorbance spectrum that is measured by Fourier transform infrared spectroscopy, an area ratio of a specific peak satisfies a predetermined relational expression, an angle dependence of diffraction efficiency is small, and heat resistance is excellent, thereby completing the present invention.

That is, the present inventors found that the object can be achieved with the following configurations.

[1] A liquid crystal diffraction element comprising:
an optically-anisotropic layer that is formed of a liquid crystal composition including a polymerizable liquid crystal compound,
in which the polymerizable liquid crystal compound includes at least one monofunctional polymerizable liquid crystal compound having one polymerizable group,
the optically-anisotropic layer has a liquid crystal alignment pattern in which an orientation of an optical axis derived from the polymerizable liquid crystal compound changes while continuously rotating in at least one in-plane direction, and
in an infrared absorbance spectrum where a measurement sample obtained by powdering the optically-anisotropic layer is measured by Fourier transform infrared spectroscopy, in a case where an area of a peak having a maximum absorbance point in a range of 2200 cm⁻¹ to 2230 cm⁻¹ is represented by A (cm⁻¹), an area of a peak having a maximum absorbance point in a range of 1630 cm⁻¹ to 1640 cm⁻¹ is represented by B (cm⁻¹), and a mass of the measurement sample is represented by M (mg), both of Expressions (1) and (2) are satisfied,

$$A / M \geq 0.35 {cm}^{- 1} {mg}^{- 1} , and \qquad Expression ( 1 )$$

$$B / M \leq 0.55 {cm}^{- 1} {mg}^{- 1} . \qquad Expression ( 2 )$$

[2] The liquid crystal diffraction element according to [1],
in which the polymerizable liquid crystal compound further includes a polyfunctional polymerizable liquid crystal compound having two or more polymerizable groups.

[3] The liquid crystal diffraction element according to [1] or [2],
in which a content of the monofunctional polymerizable liquid crystal compound is 15% by mass or more with respect to a total mass of solid content of the liquid crystal composition.

[4] The liquid crystal diffraction element according to any one of [1] to [3],
in which in an absorbance spectrum where a measurement sample obtained by powdering the optically-anisotropic layer is measured by Fourier transform infrared spectroscopy, in a case where an area of a peak having a maximum absorbance point in a range of 2200 cm⁻¹ to 2230 cm⁻¹ is represented by A (cm⁻¹) and a mass of the measurement sample is represented by M (mg), Expression (3) is satisfied,

$$A / M \geq 0.75 {cm}^{- 1} {mg}^{- 1} . \qquad Expression ( 3 )$$

[5] The liquid crystal diffraction element according to any one of [1] to [4],
in which the monofunctional polymerizable liquid crystal compound includes a compound represented by Formula (II).

[6] The liquid crystal diffraction element according to any one of [1] to [5], in which the liquid crystal composition includes a chiral compound.

[7] An optical element comprising:
the liquid crystal diffraction element according to any one of [1] to [6]; and
a circularly polarizing plate.

[8] The optical element according to [7],
in which the circularly polarizing plate includes a retardation plate and a polarizer, and
the liquid crystal diffraction element, the retardation plate, and the polarizer are provided in this order.

[9] An optical element comprising, in the following order:
the liquid crystal diffraction element according to any one of [1] to [6];
a silicon oxide layer; and
a support.

[10] An optical element comprising:
the liquid crystal diffraction element according to any one of [1] to [6]; and
a phase modulation element.

[11] The optical element according to any one of [7] to [9], further comprising:
a phase modulation element.

[12] An image display unit comprising:
the liquid crystal diffraction element according to any one of [1] to [6] or the optical element according to any one of [7] to [11].

[13] A head-mounted display comprising:
the image display unit according to [12].

[14] A beam steering comprising:
the liquid crystal diffraction element according to any one of [1] to [6] or the optical element according to any one of [7] to [11].

[15] A sensor comprising:
the liquid crystal diffraction element according to any one of [1] to [6] or the optical element according to any one of [7] to [11].

According to the present invention, it is possible to provide a liquid crystal diffraction element having a small angle dependence of diffraction efficiency and excellent heat resistance, and a liquid crystal diffraction element, an optical element, an image display unit, a head-mounted display, a beam steering, and a sensor that include the liquid crystal diffraction element.

### BRIEF DESCRIPTION OF THE DRAWINGS

FIG. 1 is a diagram conceptually showing an example of an optical element according to the present invention.

FIG. 2 is a plan view showing an optically-anisotropic layer of the optical element shown in FIG. 1.

FIG. 3 is a diagram conceptually showing an example of an exposure device for preparing a photo-alignment film.

FIG. 4 is a conceptual diagram showing an action of the optically-anisotropic layer of the optical element shown in FIG. 1.

FIG. 5 is a conceptual diagram showing the action of the optically-anisotropic layer of the optical element shown in FIG. 1.

FIG. 6 is a plan view conceptually illustrating another example of the optically-anisotropic layer.

FIG. 7 is a diagram conceptually showing an example of an exposure device that exposes a photo-alignment film forming the optically-anisotropic layer shown in FIG. 6.

FIG. 8 is a cross-sectional view conceptually showing another example of the optically-anisotropic layer.

FIG. 9 is a plan view showing the optically-anisotropic layer of the optical element shown in FIG. 8.

FIG. 10 is a diagram showing an example of an infrared absorbance spectrum used for calculating a peak area A.

FIG. 11 is a diagram showing an example of an infrared absorbance spectrum used for calculating a peak area B.

### DESCRIPTION OF THE PREFERRED EMBODIMENTS

Hereinafter, the details of the present invention will be described.

The following description regarding configuration requirements has been made based on a representative embodiment of the present invention. However, the present invention is not limited to the embodiment.

In the present specification, numerical ranges represented by “to” include numerical values before and after “to” as lower limit values and upper limit values.

In the present specification, materials that correspond to each of components may be used alone or in combination of two or more kinds. Here, in a case where two or more kinds of materials are used in combination for each of components, the content of the component refers to the total content of the materials to be combined unless specified otherwise.

In the present specification, “(meth)acrylate” represents “either or both of acrylate and methacrylate”.

### [Liquid Crystal Diffraction Element]

A liquid crystal diffraction element according to an embodiment of the present invention comprises an optically-anisotropic layer that is formed of a liquid crystal composition including a polymerizable liquid crystal compound.

In addition, as the polymerizable liquid crystal compound, at least one monofunctional polymerizable liquid crystal compound having one polymerizable group is used.

In addition, the optically-anisotropic layer has a liquid crystal alignment pattern in which an orientation of an optical axis derived from the polymerizable liquid crystal compound changes while continuously rotating in at least one in-plane direction.

In addition, in the liquid crystal diffraction element according to the embodiment of the present invention, in an infrared absorbance spectrum where a measurement sample obtained by powdering the optically-anisotropic layer is measured by Fourier transform infrared spectroscopy (hereinafter, also abbreviated as “FT-IR”), in a case where an area of a peak having a maximum absorbance point in a range of 2200 cm⁻¹ to 2230 cm⁻¹ is represented by A (cm⁻¹) (hereinafter, also abbreviated as “peak area A”), an area of a peak having a maximum absorbance point in a range of 1630 cm⁻¹ to 1640 cm⁻¹ is represented by B (cm⁻¹) (hereinafter, also abbreviated as “peak area B”), and a mass of the measurement sample is represented by M, both of Expressions (1) and (2) are satisfied.

$$A / M \geq 0.35 {cm}^{- 1} {mg}^{- 1} \qquad Expression ( 1 )$$

$$B / M \leq 0.55 {cm}^{- 1} {mg}^{- 1} \qquad Expression ( 2 )$$

### [Method of Calculating Peak Area]

As the peak area A and the peak area B in the present invention, values calculated by the following method are adopted.

### <Preparation of Measurement Sample>

First, a sample of the optically-anisotropic layer collected from the liquid crystal diffraction element by peeling, cutting, or the like is pulverized well by a mortar to obtain a uniform powdered sample.

Next, 10 mg of potassium bromide powder is added to 0.20 mg of the powdered sample, and the mixture is sufficiently mixed while being pulverized by the mortar.

Next, using a tableting press machine, a disk-like tablet having a diameter of 5 mm is prepared and used as the measurement sample.

### <FT-IR Measurement>

The obtained measurement sample is measured using a transmission method by an FT-IR spectrometer.

As the measuring device, a general FT-IR spectrometer can be used. However, in order to reduce the influence of absorption derived from water and carbon dioxide in the atmosphere on the measurement results, it is necessary to purge a device optical system and a sample chamber with dry air or high-purity nitrogen gas.

The measurement range is set to a range from 400 cm⁻¹ to 4000 cm⁻¹, and a wavenumber resolution is set to 4 cm⁻¹. As a detector, mercury cadmium telluride (MCT), triglycine sulfate (TGS), or deuterated triglycine sulfate (DTGS) is used. For background measurement, 10 mg of potassium bromide powder is pressed into as a disk-like tablet having a diameter of 5 mm and a thickness of 100 to 300 μm, and this tablet is used. The background measurement and the sample measurement are performed under the same conditions.

### Spectrum Pre-Processing>

Peaks derived from water vapor at 1300 to 2000 cm⁻¹ and 3400 to 4000 cm⁻¹ and peaks derived from carbon dioxide at 2250 to 2400 cm⁻¹ are extracted from a power spectrum during the background measurement, and each of the peaks is removed from the infrared spectrum of the sample. In the infrared spectrum of the sample after the removal, each of signals derived from water vapor and carbon dioxide is processed to be a spectrum noise level or less. The obtained infrared spectrum of the sample is converted into an infrared absorbance spectrum and used for the following the peak area calculation.

### <Calculation of Peak Area A>

The obtained FT-IR spectrum is converted into an infrared absorbance spectrum, and the area surrounded by the spectrum and the baseline is calculated as the area of the peak (peak area A) having a maximum absorbance point in a range of 2200 to 2230 cm⁻¹. Since the unit of the horizontal axis is cm⁻¹ and the unit of the vertical axis is absorbance (dimensionless), the obtained area A has a unit of cm⁻¹.

Regarding the baseline in this case, an end point on the low wavenumber side is set to a point between 2180 and 2210 cm⁻¹ and an end point on the high wavenumber side is set to a point between 2220 and 2250 cm⁻¹ in the infrared absorbance spectrum such that the baseline does not intersect the spectrum and the area surrounded by the spectrum and the baseline is maximized.

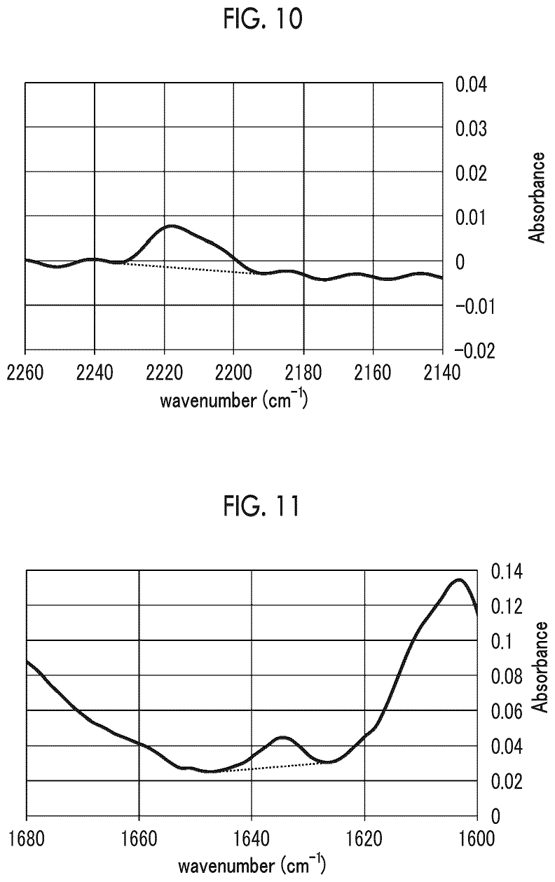

An example of the infrared absorbance spectrum used for calculating the peak area A is shown in FIG. 10. In FIG. 10, a solid line indicates the infrared absorbance spectrum, a dotted line indicates the baseline, and the area of a portion surrounded by the dotted line and the solid line is set as the peak area A.

### <Calculation of Peak Area B>

The obtained FT-IR spectrum is converted into an infrared absorbance spectrum, and the area surrounded by the spectrum and the baseline is calculated as the area of the peak (peak area B) having a maximum absorbance point in a range of 1630 to 1640 cm⁻¹. Since the unit of the horizontal axis is cm⁻¹ and the unit of the vertical axis is absorbance (dimensionless), the obtained area has a unit of cm⁻¹.

Regarding the baseline in this case, an end point on the low wavenumber side is set to a point between 1620 and 1635 cm⁻¹ and an end point on the high wavenumber side is set to a point between 1635 and 1640 cm⁻¹ in the infrared absorbance spectrum such that the baseline does not intersect the spectrum and the area surrounded by the spectrum and the baseline is maximized.

An example of the infrared absorbance spectrum used for calculating the peak area B is shown in FIG. 11. In FIG. 11, a solid line indicates the infrared absorbance spectrum, a dotted line indicates the baseline, and the area of a portion surrounded by the dotted line and the solid line is set as the peak area B.

### <Expressions (1) and (2)>

The value on the left side of Expression (1) can be calculated by dividing the value of the peak area A (cm⁻¹) by the mass M (mg) of the measurement sample.

Likewise, the value on the left side of Expression (2) can be calculated by dividing the value of the peak area B (cm⁻¹) by the mass M (mg) of the measurement sample.

$$A / M \geq 0.35 {cm}^{- 1} {mg}^{- 1} \qquad Expression ( 1 )$$

$$B / M \leq 0.55 {cm}^{- 1} {mg}^{- 1} \qquad Expression ( 2 )$$

In the present invention, as described above, the liquid crystal diffraction element includes the optically-anisotropic layer that is formed of the liquid crystal composition including at least one monofunctional polymerizable liquid crystal compound having one polymerizable group and satisfies both of Expressions (1) and (2). As a result, the angle dependence of diffraction efficiency of the liquid crystal diffraction element is small, and heat resistance is also excellent.

The details of the reason for this are not clear, but the present inventors presumed the reason to be as follows.

First, it is presumed that, by using the monofunctional polymerizable liquid crystal compound, the occurrence of distortion in the optically-anisotropic layer during the curing of the liquid crystal composition (during the formation of the optically anisotropic layer) can be suppressed, and thus heat resistance is improved. The reason for this is presumed to be that, in a case where the liquid crystal diffraction element is reheated during molding or the like, a phenomenon in which stress is relaxed at a portion where the distortion of the optically-anisotropic layer occurs such that the diffraction efficiency of the liquid crystal diffraction element changes can be prevented in advance.

In addition, Expression (1) being satisfied represents that the number of carbon-carbon triple bonds (—C≡C—) having an absorption in a range of 2200 to 2230 cm⁻¹ is large to some extent or more in the molecules. As a result, it is presumed that the refractive index of the optically-anisotropic layer increases, the thickness can be designed to be small, and thus the angle dependence of diffraction efficiency of the liquid crystal diffraction element is reduced.

In addition, Expression (2) being satisfied represents that the number of carbon-carbon double bonds (—C═C—) remaining in the molecules is small to some extent or less. As a result, it is presumed that, in a case where the liquid crystal diffraction element is reheated during molding or the like, the progress of a polymerization reaction can be suppressed, and thus heat resistance can be improved.

In the liquid crystal diffraction element according to the embodiment of the present invention, from the viewpoint of further reducing the angle dependence of diffraction efficiency, It is preferable that, in an infrared absorbance spectrum where a measurement sample obtained by powdering the optically-anisotropic layer is measured by FT-IR, in a case where a peak area having a maximum absorbance point in a range of 2200 cm⁻¹ to 2230 cm⁻¹ is represented by a peak area A and a mass of the measurement sample is represented by M, Expression (3) is satisfied.

$$A / M \geq 0.75 {cm}^{- 1} {mg}^{- 1} \qquad Expression ( 3 )$$

In addition, in the liquid crystal diffraction element according to the embodiment of the present invention, in an infrared absorbance spectrum where a measurement sample obtained by powdering the optically-anisotropic layer is measured by FT-IR, in a case where peak area having a maximum absorbance point in a range of 2200 cm⁻¹ to 2230 cm⁻¹ is represented by a peak area A (cm⁻¹), a peak area having a maximum absorbance point in a range of 1630 cm⁻¹ to 1640 cm⁻¹ is represented by a peak area B (cm⁻¹), and a mass of the measurement sample is represented by M (mg), it is preferable that at least one of Expression (1-2) or (2-2) is satisfied, and it is preferable that both of Expression (1-2) and (2-2) are satisfied.

$$1.2 \geq A / M \geq 0.35 {cm}^{- 1} {mg}^{- 1} \qquad Expression ( 1 - 2 )$$

$$0.2 \leq B / M \leq 0.55 {cm}^{- 1} {mg}^{- 1} \qquad Expression ( 2 - 2 )$$

In the present invention, the value of “A/M” in Expressions (1), (1-2), and (3) can be adjusted depending on, for example, the kind, the content, and the like of the polymerizable liquid crystal compound in the liquid crystal composition. Specifically, the value of “A/M” can be adjusted by appropriately selecting and mixing compounds having different contents of carbon-carbon triple bonds as the polymerizable liquid crystal compound. More specifically, in a case where a compound represented by Formula (I) is used as the polymerizable liquid crystal compound, for example, the content thereof is set to 50% by mass or more with respect to the total mass of solid content of the liquid crystal composition such that the value of “A/M” can be adjusted.

In addition, in the present invention, the value of “B/M” in Expressions (2) and (2-2) can be adjusted depending on, for example, the kind, the content, and the like of the polymerizable liquid crystal compound in the liquid crystal composition or the curing (polymerization) conditions of the liquid crystal composition. Specifically, the value of “B/M” can be adjusted by increasing the content of the monofunctional polymerizable liquid crystal compound or by changing the curing conditions, for example, by increasing the amount of a polymerization initiator, increasing the irradiation amount of light during polymerization, or increasing the temperature during polymerization.

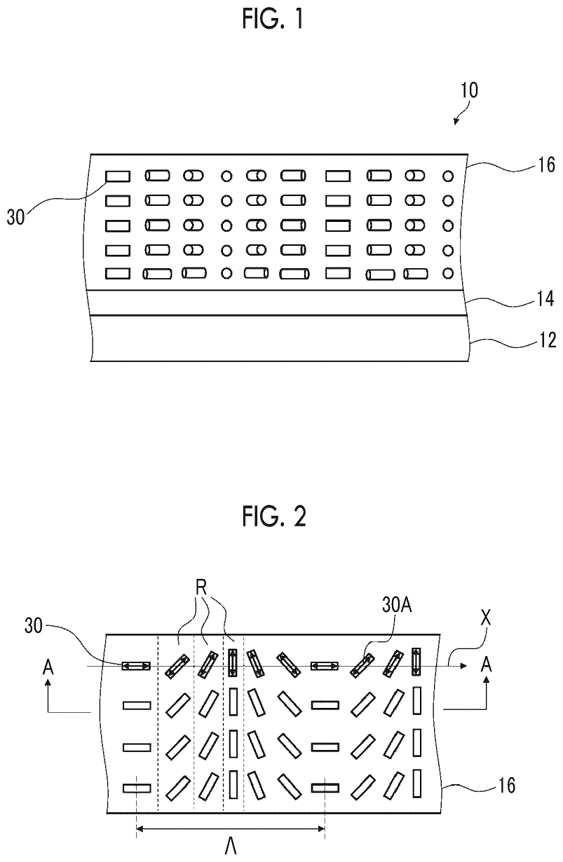

FIG. 1 is a side view conceptually showing an example of the liquid crystal diffraction element according to the embodiment of the present invention. FIG. 2 is a plan view showing the liquid crystal diffraction element shown in FIG. 1. The plan view is a view in a case where a liquid crystal diffraction element 10 is seen from the top in FIG. 1. That is, FIG. 1 is a view in a case where the liquid crystal diffraction element 10 is seen from a thickness direction (laminating direction of the respective layers (films)). In other words, FIG. 1 is a view in a case where an optically-anisotropic layer 16 is seen from a direction orthogonal to a main surface.

In order to clearly show a configuration of the liquid crystal diffraction element 10 according to the embodiment of the present invention, FIG. 2 shows only a polymerizable liquid crystal compound 30 on a side of an optically-anisotropic layer 16 opposite to a photo-alignment film 14 side. However, as shown in FIG. 1, the optically-anisotropic layer 16 has a structure in which the polymerizable liquid crystal compound 30 is laminated in the thickness direction.

As shown in FIG. 1, the liquid crystal diffraction element 10 includes a support 12, the photo-alignment film 14, and the optically-anisotropic layer 16. The optically-anisotropic layer 16 is formed of a liquid crystal composition and has a predetermined liquid crystal alignment pattern in which an orientation of an optical axis derived from the liquid crystal compound rotates in one in-plane direction.

The liquid crystal diffraction element 10 in the example shown in the drawing includes the support 12, the photo-alignment film 14, and the optically-anisotropic layer 16. However, the liquid crystal diffraction element according to the embodiment of the present invention is no limited to this configuration.

Hereinafter, each of the members forming the liquid crystal diffraction element 10 will be described in detail.

### [Support]

The support 12 supports the photo-alignment film 14 and the optically-anisotropic layer 16.

As the support 12, various sheet-shaped materials (films or plate-shaped materials) can be used as long as they can support the photo-alignment film 14 and the optically-anisotropic layer 16.

A transmittance of the support 12 with respect to corresponding light is preferably 50% or more, more preferably 70% or more, and still more preferably 85% or more.

The thickness of the support 12 is not particularly limited and may be appropriately set depending on the use of the liquid crystal diffraction element 10, a material for forming the support 12, and the like in a range where the photo-alignment film 14 and the optically-anisotropic layer 16 can be supported.

The thickness of the support 12 is preferably 1 to 1000 μm, more preferably 3 to 250 μm, and still more preferably 5 to 150 μm.

The support 12 may have a monolayer structure or a multi-layer structure.

In a case where the support 12 has a monolayer structure, examples thereof include supports formed of glass, triacetyl cellulose, polyethylene terephthalate, polycarbonates, polyvinyl chloride, poly (meth)acrylate, polyolefin, and the like. In a case where the support 12 has a multi-layer structure, examples thereof include a support including: one of the above-described supports having a monolayer structure that is provided as a substrate; and another layer that is provided on a surface of the substrate.

### [Photo-Alignment Film]

The photo-alignment film 14 is an alignment film for aligning the polymerizable liquid crystal compound 30 to the predetermined liquid crystal alignment pattern during the formation of the optically-anisotropic layer 16 of the liquid crystal diffraction element 10.

Although described below, the optically-anisotropic layer 16 has a liquid crystal alignment pattern in which an orientation of an optical axis 30A derived from the polymerizable liquid crystal compound 30 changes while continuously rotating in one in-plane direction. Accordingly, the photo-alignment film 14 is formed such that the optically-anisotropic layer 16 can form the liquid crystal alignment pattern.

In the following description, “the orientation of the optical axis 30A rotates” will also be simply referred to as “the optical axis 30A rotates”.

Preferable examples of the photo-alignment material used in the photo-alignment film 14 include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate (cinnamic acid) compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-012823A.

Among these, an azo compound, a photocrosslinking polyimide, a photocrosslinking polyamide, a photocrosslinking polyester, a cinnamate compound, or a chalcone compound is suitably used.

A method of forming the photo-alignment film 14 is not particularly limited, and examples thereof include a method including: applying a composition for forming a photo-alignment film including a predetermined photo-alignment material to a surface of the support 12; drying the applied composition to obtain the coating film (photo-alignment film precursor); and exposing the coating film to laser light to form an alignment pattern.

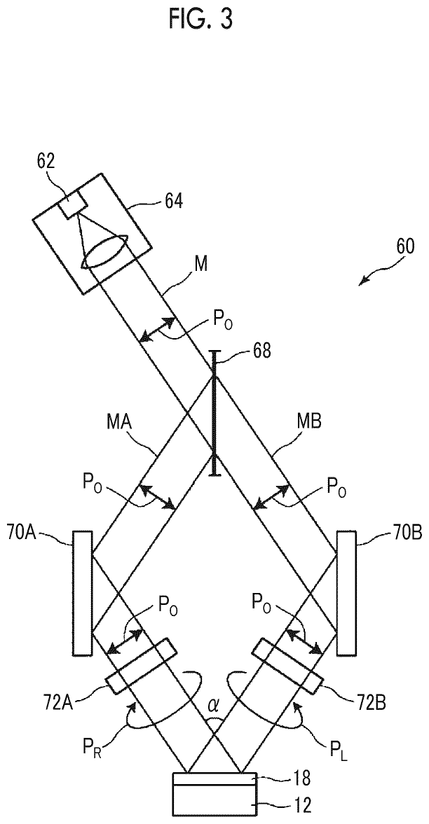

FIG. 3 conceptually shows an example of an exposure device that forms the alignment pattern.

An exposure device 60 shown in FIG. 3 includes: a light source 64 that includes a laser 62; a beam splitter 68 that splits laser light M emitted from the laser 62 into two beams MA and MB; mirrors 70A and 70B that are disposed on optical paths of the split two beams MA and MB; and λ/4 plates 72A and 72B.

Although not shown in the drawing, the light source 64 emits linearly polarized light P₀. The λ/4 plate 72A converts the linearly polarized light P₀ (beam MA) into right circularly polarized light P_{R}, and the λ/4 plate 72B converts the linearly polarized light P₀ (beam MB) into left circularly polarized light P_{L}.

The support 12 including a coating film 18 on which the alignment pattern is not yet formed is disposed at an exposed portion, the two beams MA and MB intersect and interfere with each other on the coating film 18, and the coating film 18 is irradiated with and exposed to the interference light.

Due to the interference in this case, the polarization state of light with which the coating film 18 is irradiated periodically changes according to interference fringes. As a result, the photo-alignment film 14 having the alignment pattern in which the alignment state periodically changes can be obtained.

In the exposure device 60, by changing an intersecting angle α between the two beams MA and MB, the period of the alignment pattern can be adjusted. That is, by adjusting the intersecting angle α in the exposure device 60, in the crystal alignment pattern in which the orientation of the optical axis 30A derived from the polymerizable liquid crystal compound 30 continuously rotates in the one direction, the length (single period A) of the single period over which the orientation of the optical axis 30A rotates by 180° in the one direction in which the orientation of the optical axis 30A rotates can be adjusted.

By forming the optically-anisotropic layer on the photo-alignment film having the alignment pattern in which the alignment state periodically changes, as described below, the optically-anisotropic layer 16 having the liquid crystal alignment pattern in which the orientation of the optical axis 30A derived from the polymerizable liquid crystal compound 30 continuously rotates in the one direction can be formed.

In addition, by rotating the optical axes of the λ/4 plates 72A and 72B by 90°, respectively, the rotation direction of the optical axis 30A can be reversed.

The alignment film will be described above as an example of the photo-alignment film. In the liquid crystal diffraction element according to the embodiment of the present invention, another alignment film (for example, a rubbed alignment film) may be used instead of the photo-alignment film.

In addition, the alignment pattern may be provided on the support without providing the alignment film. Specifically, the optically-anisotropic layer 16 may be formed directly on the support 12 by forming the alignment pattern on the support 12 using a method of rubbing the support 12, a method of processing the support 12 with laser light or the like, or the like.

### [Optically-Anisotropic Layer]

The optically-anisotropic layer 16 is formed of a liquid crystal composition including a polymerizable liquid crystal compound described below.

As shown in FIG. 2, the optically-anisotropic layer 16 has the liquid crystal alignment pattern in which the orientation of the optical axis 30A derived from the polymerizable liquid crystal compound 30 changes while continuously rotating counterclockwise in the one direction indicated by arrow X in a plane of the optically anisotropic layer 16. In FIG. 2, the orientation of the optical axis 30A derived from the polymerizable liquid crystal compound 30 rotates counterclockwise. However, the present invention is not limited to this aspect, and the orientation of the optical axis 30A may rotate clockwise.

The optical axis 30A derived from the polymerizable liquid crystal compound 30 is an axis having the highest refractive index in the polymerizable liquid crystal compound 30. For example, in a case where the polymerizable liquid crystal compound 30 is a rod-like liquid crystal compound, the optical axis 30A is along a rod-like major axis direction. In a case where the polymerizable liquid crystal compound 30 is a disk-like liquid crystal compound, the optical axis 30A is along a direction orthogonal to a disk plane.

In the following description, “one direction indicated by arrow X” will also be simply referred to as “arrow X direction”. In addition, in the following description, the optical axis 30A derived from the polymerizable liquid crystal compound 30 will also be referred to as “the optical axis 30A of the polymerizable liquid crystal compound 30” or “the optical axis 30A”.

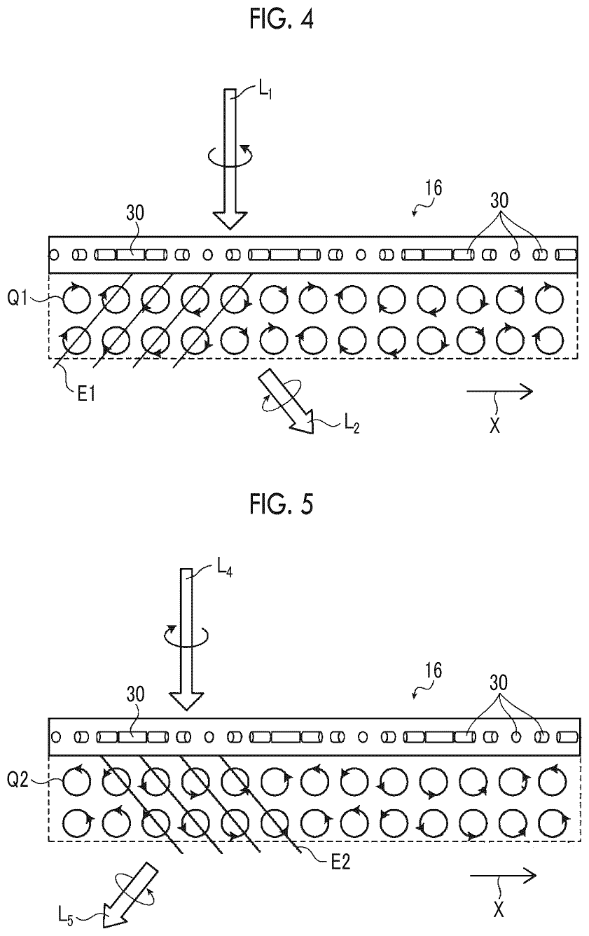

In the optically-anisotropic layer 16, the polymerizable liquid crystal compound 30 is two-dimensionally aligned in a plane parallel to the arrow X direction and a Y direction orthogonal to the arrow X direction. In FIG. 1 and FIGS. 4, 5, and 8 described below, the Y direction is a direction perpendicular to the paper plane.

FIG. 2 conceptually shows a plan view of the optically-anisotropic layer 16.

The optically-anisotropic layer 16 has the liquid crystal alignment pattern in which the orientation of the optical axis 30A derived from the polymerizable liquid crystal compound 30 changes while continuously rotating in the arrow X direction in a plane of the optically-anisotropic layer 16.

Specifically, “the orientation of the optical axis 30A of the polymerizable liquid crystal compound 30 changes while continuously rotating in the arrow X direction (the predetermined one direction)” represents that an angle between the optical axis 30A of the polymerizable liquid crystal compound 30, which is arranged in the arrow X direction, and the arrow X direction varies depending on positions in the arrow X direction, and the angle between the optical axis 30A and the arrow X direction sequentially changes from θ to θ+180° or θ−180° in the arrow X direction.

A difference between the angles of the optical axes 30A of the polymerizable liquid crystal compound 30 adjacent to each other in the arrow X direction is preferably 45° or less, more preferably 15° or less, and still more preferably less than 15°.

On the other hand, regarding the polymerizable liquid crystal compound 30 forming the optically-anisotropic layer 16, the polymerizable liquid crystal compound 30 having the same orientation of the optical axes 30A are arranged at regular intervals in the Y direction orthogonal to the arrow X direction, that is, the Y direction orthogonal to the one direction in which the optical axis 30A continuously rotates.

In other words, regarding the polymerizable liquid crystal compound 30 forming the optically-anisotropic layer 16, in the polymerizable liquid crystal compound 30 arranged in the Y direction, angles between the orientations of the optical axes 30A and the arrow X direction are the same.

In the liquid crystal diffraction element 10, in the liquid crystal alignment pattern of the polymerizable liquid crystal compound 30, the length (distance) over which the optical axis 30A of the polymerizable liquid crystal compound 30 rotates by 180° in the arrow X direction in which the orientation of the optical axis 30A changes while continuously rotating in a plane is the length A of the single period in the liquid crystal alignment pattern. In other words, the length of the single period in the liquid crystal alignment pattern is defined as the distance between θ and θ+180° that is a range of the angle between the optical axis 30A of the polymerizable liquid crystal compound 30 and the arrow X direction.

That is, a distance between centers of two polymerizable liquid crystal compounds 30 in the arrow X direction is the length A of the single period, the two polymerizable liquid crystal compounds 30 having the same angle in the arrow X direction. Specifically, as shown in FIG. 2, a distance of centers in the arrow X direction of two polymerizable liquid crystal compounds 30 in which the arrow X direction and the direction of the optical axis 30A match each other is the length Λ of the single period. In the following description, the length Λ of the single period will also be referred to as “single period Λ”.

In the liquid crystal diffraction element 10 according to the embodiment of the present invention, in the liquid crystal alignment pattern of the optically-anisotropic layer 16, the single period Λ is repeated in the arrow X direction, that is, in the one direction in which the orientation of the optical axis 30A changes while continuously rotating.

As described above, in the polymerizable liquid crystal compounds 30 arranged in the Y direction in the optically-anisotropic layer 16, the angles between the optical axes 30A and the arrow X direction (the one direction in which the orientation of the optical axis of the polymerizable liquid crystal compound 30 rotates) are the same. Regions where the polymerizable liquid crystal compounds 30 in which the angles between the optical axes 30A and the arrow X direction are the same are disposed in the Y direction will be referred to as “regions R”.

In this case, it is preferable that an in-plane retardation (Re) value of each of the regions R is a half wavelength, that is, λ/2. The in-plane retardation is calculated from the product of a difference Δn in refractive index generated by refractive index anisotropy of the region R and the thickness of the optically-anisotropic layer. Here, the difference in refractive index generated by refractive index anisotropy of the region R in the optically-anisotropic layer is defined by a difference between a refractive index of a direction of an in-plane slow axis of the region R and a refractive index of a direction orthogonal to the direction of the slow axis. That is, the difference Δn in refractive index generated by refractive index anisotropy of the region R is the same as a difference between a refractive index of the polymerizable liquid crystal compound 30 in the direction of the optical axis 30A and a refractive index of the polymerizable liquid crystal compound 30 in a direction perpendicular to the optical axis 30A in a plane of the region R. That is, the difference Δn in refractive index is the same as the difference in refractive index of the liquid crystal compound.

In a case where circularly polarized light is incident into the above-described optically-anisotropic layer 16, the light is refracted such that the direction of the circularly polarized light is converted.

This action is conceptually shown in FIG. 4 using the optically-anisotropic layer 16 as an example. In the optically-anisotropic layer 16, the value of the product of the difference in refractive index of the liquid crystal compound and the thickness of the optically-anisotropic layer is λ/2. In FIG. 4, in order to simplify the drawings, the number of the polymerizable liquid crystal compounds 30 in the optically-anisotropic layer 16 is reduced and shown.

As shown in FIG. 4, in a case where the value of the product of the difference in refractive index of the polymerizable liquid crystal compound in the optically-anisotropic layer 16 and the thickness of the optically-anisotropic layer is λ/2 and incidence light L₁ as left circularly polarized light is incident into the optically-anisotropic layer 16, the incidence light L₁ transmits through the optically-anisotropic layer 16 to be imparted with a phase difference of 180°, and transmitted light L₂ is converted into right circularly polarized light.

In addition, in a case where the incidence light L₁ transmits through the optically-anisotropic layer 16, an absolute phase thereof changes depending on the orientation of the optical axis 30A of each of the polymerizable liquid crystal compounds 30. In this case, the orientation of the optical axis 30A changes while rotating in the arrow X direction. Therefore, the amount of change in the absolute phase of the incidence light L₁ varies depending on the orientation of the optical axis 30A. Further, the liquid crystal alignment pattern that is formed in the optically-anisotropic layer 16 is a pattern that is periodic in the arrow X direction. Therefore, as shown in FIG. 4, the incidence light L₁ transmitted through the optically-anisotropic layer 16 is imparted with an absolute phase Q1 that is periodic in the arrow X direction corresponding to the orientation of each of the optical axes 30A. As a result, an equiphase surface E1 that is tilted in a direction opposite to the arrow X direction is formed.

Therefore, the transmitted light L₂ is refracted to be tilted in a direction perpendicular to the equiphase surface E1 and travels in a direction different from a traveling direction of the incidence light L₁. This way, the incidence light L₁ of the left circularly polarized light is converted into the transmitted light L₂ of right circularly polarized light that is tilted by a predetermined angle in the arrow X direction with respect to an incidence direction.

On the other hand, as conceptually shown in FIG. 5, in a case where the value of the product of the difference in refractive index of the polymerizable liquid crystal compound in the optically-anisotropic layer 16 and the thickness of the optically-anisotropic layer is λ/2 and incidence light L₄ as right circularly polarized light is incident into the optically-anisotropic layer 16, the incidence light L₄ transmits through the optically-anisotropic layer 16 to be imparted with a phase difference of 180° and is converted into transmitted light L₅ of left circularly polarized light.

In addition, in a case where the incidence light L₄ transmits through the optically-anisotropic layer 16, an absolute phase thereof changes depending on the orientation of the optical axis 30A of each of the polymerizable liquid crystal compounds 30. In this case, the orientation of the optical axis 30A changes while rotating in the arrow X direction. Therefore, the amount of change in the absolute phase of the incidence light L₄ varies depending on the orientation of the optical axis 30A. Further, the liquid crystal alignment pattern that is formed in the optically-anisotropic layer 16 is a pattern that is periodic in the arrow X direction. Therefore, as shown in FIG. 5, the incidence light L₄ transmitted through the optically-anisotropic layer 16 is imparted with an absolute phase Q2 that is periodic in the arrow X direction corresponding to the orientation of each of the optical axes 30A.

Here, the incidence light L₄ is right circularly polarized light. Therefore, the absolute phase Q2 that is periodic in the arrow X direction corresponding to the orientation of the optical axis 30A is opposite to the incidence light L₁ as left circularly polarized light. As a result, in the incidence light L₄, an equiphase surface E2 that is tilted in the arrow X direction opposite to that of the incidence light L₁ is formed.

Therefore, the incidence light L₄ is refracted to be tilted in a direction perpendicular to the equiphase surface E2 and travels in a direction different from a traveling direction of the incidence light L₄. This way, the incidence light L₄ is converted into the transmitted light L₅ of left circularly polarized light that is tilted by a predetermined angle in a direction opposite to the arrow X direction with respect to an incidence direction.

In the optically-anisotropic layer 16, it is preferable that the in-plane retardation value of the plurality of regions R is a half wavelength. It is preferable that an in-plane retardation Re(550)=Δn₅₅₀×d of the plurality of regions R of the optically-anisotropic layer 16 with respect to the incidence light having a wavelength of 550 nm is in a range defined by Expression (4). Here, Δn₅₅₀ represents a difference in refractive index generated by refractive index anisotropy of the region R in a case where the wavelength of incidence light is 550 nm, and d represents the thickness of the optically-anisotropic layer 16.

$$200 nm \leq Δ {n}_{550} \times d \leq 350 nm \qquad ( 4 )$$

That is, in a case where the in-plane retardation Re(550)=Δn₅₅₀×d of the plurality of regions R of the optically-anisotropic layer 16 satisfies Expression (4), a sufficient amount of a circularly polarized light component in light incident into the optically-anisotropic layer 16 can be converted into circularly polarized light that travels in a direction tilted in a forward direction or reverse direction with respect to the arrow X direction. It is more preferable that the in-plane retardation Re(550)=Δn₅₅₀×d satisfies 225 nm≤Δn₅₅₀×d≤340 nm, and it is still more preferable that the in-plane retardation Re(550)=Δn₅₅₀×d satisfies 250 nm≤Δn₅₅₀×d≤330 nm.

Expression (4) is a range with respect to incidence light having a wavelength of 550 nm. However, an in-plane retardation Re(λ)=Δnλ×d of the plurality of regions R of the optically-anisotropic layer with respect to incidence light having a wavelength of λ nm is preferably in a range defined by Expression (4-2) and can be appropriately set.

$$0 \text{.7} λ nm \leq Δ n λ \times d \leq 1.3 λ nm \qquad ( 4 - 2 )$$

In addition, the in-plane retardation value of the plurality of regions R of the optically-anisotropic layer 16 in a range outside the range of Expression (4) can also be used. Specifically, by satisfying Δn₅₅₀×d<200 nm or 350 nm<Δn₅₅₀×d, the light can be classified into light that travels in the same direction as a traveling direction of the incidence light and light that travels in a direction different from a traveling direction of the incidence light. In a case where Δn₅₅₀×d approaches 0 nm or 550 nm, the amount of the light component that travels in the same direction as a traveling direction of the incidence light increases, and the amount of the light component that travels in a direction different from a traveling direction of the incidence light decreases.

Further, it is preferable that an in-plane retardation Re(450)=Δn₄₅₀×d of each of the regions R of the optically-anisotropic layer 16 with respect to incidence light having a wavelength of 450 nm and an in-plane retardation Re(550)=Δn₅₅₀×d of each of the regions R of the optically-anisotropic layer 16 with respect to incidence light having a wavelength of 550 nm satisfy Expression (5). Here, Δn₄₅₀ represents a difference in refractive index generated by refractive index anisotropy of the region R in a case where the wavelength of incidence light is 450 nm.

$$( Δ {n}_{450} \times d ) / ( Δ {n}_{550} \times d ) < 1.0 \qquad ( 5 )$$

Expression (5) represents that the polymerizable liquid crystal compound 30 in the optically-anisotropic layer 16 has reverse dispersibility. That is, by satisfying Expression (5), the optically-anisotropic layer 16 can correspond to incidence light having a wide wavelength range.

Here, by changing the single period Λ of the liquid crystal alignment pattern formed in the optically-anisotropic layer 16, refraction angles of the transmitted light components L₂ and L₅ can be adjusted. Specifically, as the single period Λ of the liquid crystal alignment pattern decreases, light components transmitted through the polymerizable liquid crystal compounds 30 adjacent to each other more strongly interfere with each other. Therefore, the transmitted light components L₂ and L₅ can be more largely refracted.

In addition, refraction angles of the transmitted light components L₂ and L₅ with respect to the incidence light components L₁ and L₄ vary depending on the wavelengths of the incidence light components L₁ and L₄ (the transmitted light components L₂ and L₅). Specifically, as the wavelength of incidence light increases, the transmitted light is largely refracted. That is, in a case where incidence light is red light, green light, and blue light, the red light is refracted to the highest degree, and the blue light is refracted to the lowest degree.

Further, by reversing the rotation direction of the optical axis 30A of the polymerizable liquid crystal compound 30 that rotates in the arrow X direction, the refraction direction of transmitted light can be reversed.

It is not necessary that the 180° rotation period in the optically-anisotropic layer is uniform over the entire surface. That is, the optically anisotropic film may have regions having different lengths of the 180° rotation periods (lengths Λ of the single periods) in a plane.

A minimum value of the length of the single period over which the orientation of the optical axis derived from the liquid crystal composition rotates by 180° in a plane is preferably 20 μm or less, more preferably 5 μm or less, and still more preferably 2 μm or less. The lower limit is not particularly limited and is 0.5 μm or more in many cases.

In addition, the optically-anisotropic layer may have a portion where the orientation of the optical axis is constant as long as a part thereof has the liquid crystal alignment pattern in which the orientation of the optical axis rotates in at least one in-plane direction.

The thickness of the optically-anisotropic layer is not particularly limited and is preferably ¼ times the minimum value of the length of the single period over which the orientation of the optical axis derived from the liquid crystal composition rotates by 180° in a plane. The upper limit is not particularly limited and is less than or equal to two times the minimum value of the length of the single period in many cases.

The thickness of the optically-anisotropic layer is not particularly limited, but is preferably 0.1 μm or more, more preferably 0.5 μm or more, and still more preferably 1.5 μm or more. The upper limit is not particularly limited and is preferably 20 μm or less and more preferably 15 or μm or less.

The method of forming the optically-anisotropic layer is not particularly limited. For example, by forming the photo-alignment film 14 on the support 12, applying the liquid crystal composition to the photo-alignment film 14, and curing the applied liquid crystal composition, the optically-anisotropic layer 16 consisting of the cured layer of the liquid crystal composition can be obtained. That is, the optically-anisotropic layer is formed of a cured layer of a liquid crystal composition including a polymerizable liquid crystal compound.

Although the optically-anisotropic layer 16 functions as a so-called λ/2 plate, the present invention includes an aspect where a laminate including the support 12 and the photo-alignment film 14 that are integrated functions as a λ/2 plate.

As described above, the liquid crystal composition for forming the optically-anisotropic layer 16 is a liquid crystal composition including a polymerizable liquid crystal compound.

### <Polymerizable Liquid Crystal Compound>

The polymerizable liquid crystal compound in the liquid crystal composition is not particularly limited as long as it is a liquid crystal compound having a polymerizable group, and any one of a rod-like liquid crystal compound or a disk-like liquid crystal compound can be used. Here, in the present invention, as described above, at least one monofunctional polymerizable liquid crystal compound having one polymerizable group is used as the polymerizable liquid crystal compound.

In addition, as the liquid crystal compound, any one of a low-molecular-weight liquid crystal compound or a polymer liquid crystal compound can be used.

Here, “low-molecular-weight liquid crystal compound” refers to a liquid crystal compound not including a repeating unit in a chemical structure.

In addition, “polymer liquid crystal compound” refers to a liquid crystal compound including a repeating unit in a chemical structure.

The polymerizable group in the liquid crystal compound is not particularly limited, and a radically polymerizable or cationically polymerizable group is preferable.

As the radically polymerizable group, a well-known radically polymerizable group can be used, and preferable examples thereof include an acryloyloxy group and a methacryloyloxy group. In this case, it is generally known that the polymerization rate of an acryloyloxy group is fast, and from the viewpoint of improving productivity, an acryloyloxy group is preferable. However, a methacryloyloxy group can also be used as the polymerizable group.

As the cationically polymerizable group, a well-known cationically polymerizable group can be used, and specific examples thereof include an alicyclic ether group, a cyclic acetal group, a cyclic lactone group, a cyclic thioether group, a spiro ortho ester group, and a vinyloxy group. In particular, an alicyclic ether group or a vinyloxy group is preferable, and an epoxy group, an oxetanyl group, or a vinyloxy group is more preferable.

Examples of the more preferable polymerizable group include a polymerizable group represented by any one of Formulas (P-1) to (P-20). In particular, an acryloyloxy group represented by Formula (P-1) or a methacryloyloxy group represented by Formula (P-2) is more preferable.

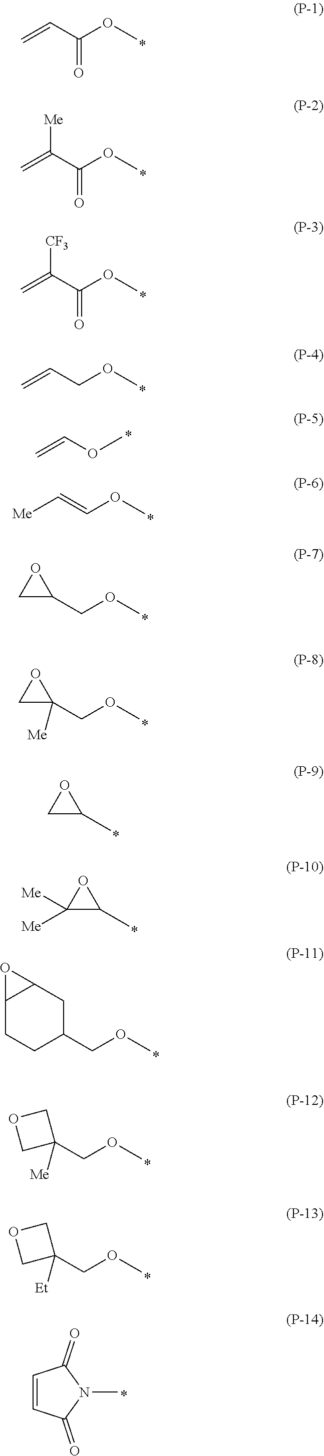

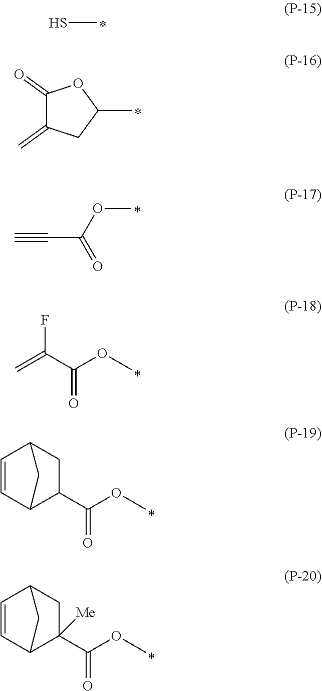

Examples of the polymerizable liquid crystal compound include compounds described in JP2013-112631A, JP2010-70543A, JP4725516B, JP2001-328973A, JP2011-207942A, JP2012-006996A, JP2012-006843A, JP2005-531618A, JP2004-534100A, JP2008-512504A, JP2011-510915A, JP2016-509247A, and WO2019/182129A.

In the present invention, in a case where the optically-anisotropic layer is prepared by laminating the liquid crystal compositions, from the viewpoint of easily controlling the film thickness of the laminated coating, it is preferable that a polyfunctional polymerizable liquid crystal compound having two or more polymerizable groups is used in combination as the polymerizable liquid crystal compound.

In addition, in the present invention, from the viewpoint of increasing the diffraction efficiency of the liquid crystal diffraction element, it is preferable that a liquid crystal compound having high refractive index anisotropy Δn is used as the polymerizable liquid crystal compound. By increasing the refractive index anisotropy, a high diffraction efficiency can be maintained in a case where the incidence angle changes.

The liquid crystal compound having high refractive index anisotropy Δn is not particularly limited, and preferable examples thereof include compounds described in JP2005-531618A, JP2004-534100A, JP2008-512504A, JP2011-510915A, JP2016-509247A, and WO2019/182129A, and a compound represented by Formula (I).

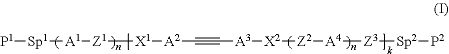

In Formula (I), P¹ and P² each independently represent a hydrogen atom, —CN, —NCS, or a polymerizable group. Here, at least one of P¹ or P² represents a polymerizable group. Among the compounds represented by Formula (I), a compound where one of P¹ or P² represents a polymerizable group corresponds to a monofunctional polymerizable liquid crystal compound, and a compound where both of P¹ and P² represent a polymerizable group corresponds to a polyfunctional polymerizable liquid crystal compound.

Sp¹ and Sp² each independently represent a single bond or a divalent linking group. Here, Sp¹ and Sp² do not represent a divalent linking group including at least one group selected from the group consisting of an aromatic hydrocarbon ring group, an aromatic heterocyclic group, and an aliphatic hydrocarbon ring group.

k represents an integer of 2 to 4.

m and n each independently represent an integer of 0 to 3. Here, a plurality of m's may be the same as or different from each other.

Z¹, Z², and Z³ each independently represent a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR=CR—, —CR=N—, —N═CR—, —N═N—, —CR=N—N═CR—, —CF=CF—, or —C≡C—. R represents a hydrogen atom or an alkyl group having 1 to 10 carbon atoms. In a case where a plurality of R's are present, the plurality of R's may be the same as or different from each other. Here, in a case where n represents an integer of 2 or 3, a plurality of Z¹'s may be the same as or different from each other. In a case where m represents an integer of 1 to 3, a plurality of Z²'s may be the same as or different from each other. A plurality of Z³'s may be the same as or different from each other. In addition, Z³ linked to Sp² represents a single bond.

X¹ and X² each independently represent a single bond, —O—, or —S—. Here, a plurality of X¹'s may be the same as or different from each other, and a plurality of X²'s may be the same as or different from each other.

A¹, A², A³, and A⁴ each independently represent a group represented by any one of Formulas (B-1) to (B-7) or a group where two or three groups among the groups represented by Formulas (B-1) to (B-7) are linked. Here, in a case where n represents an integer of 2 or 3, a plurality of A¹'s may be the same as or different from each other. A plurality of A²'s may be the same as or different from each other, and a plurality of A³'s may be the same as or different from each other. In a case where m represents an integer of 1 to 3, a plurality of A⁴'s may be the same as or different from each other.

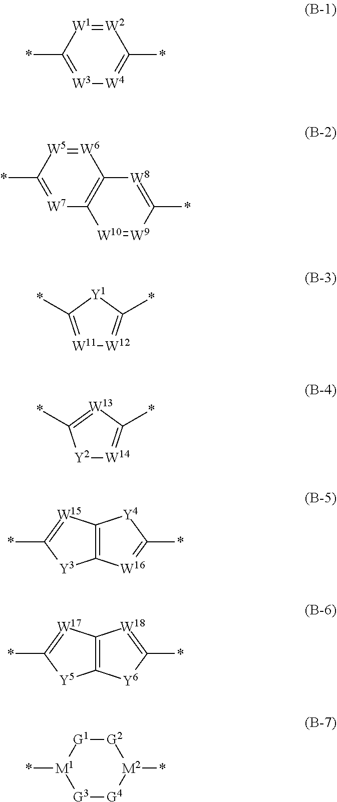

In Formulae (B-1) to (B-7), W¹ to W⁸ each independently represent CR¹ or N, and R¹ represents a hydrogen atom or the following substituent L.

Y¹ to Y⁶ each independently represent NR², O, or S, and R² represents a hydrogen atom or the following substituent L.

G¹ to G⁴ each independently represent CR³R⁴, NR⁵, O, or S, and R³ to R⁵ each independently represent a hydrogen atom or the following substituent L.

M¹ and M² each independently represent CR⁶ or N, and R⁶ represents a hydrogen atom or the following substituent L.

* represents a bonding position.

### (Substituent L)

The substituent L represents an alkyl group having 1 to 10 carbon atoms, an alkoxy group having 1 to 10 carbon atoms, an alkylamino group having 1 to 10 carbon atoms, an alkylthio group having 1 to 10 carbon atoms, an alkanoyl group having 1 to 10 carbon atoms, an alkanoyloxy group having 1 to 10 carbon atoms, an alkanoylamino group having 1 to 10 carbon atoms, an alkanoylthio group having 1 to 10 carbon atoms, an alkyloxycarbonyl group having 2 to 10 carbon atoms, an alkylaminocarbonyl group having 2 to 10 carbon atoms, an alkylthiocarbonyl group having 2 to 10 carbon atoms, a hydroxy group, an amino group, a mercapto group, a carboxy group, a sulfo group, an amide group, a cyano group, a nitro group, a halogen atom, or a polymerizable group.

Here, in a case where the group described as the substituent L has —CH₂—, a group in which at least one —CH₂— in the group is substituted with —O—, —CO—, —CH═CH—, or —C≡C— is also included in the substituent L.

Here, in a case where the group described as the substituent L has a hydrogen atom, a group in which at least one hydrogen atom—in the group is substituted with at least one selected from the group consisting of a fluorine atom and a polymerizable group is also included in the substituent L.

Examples of the divalent linking group in one aspect of Sp¹ and Sp² in Formula (I) include a linear or branched alkylene group having 1 to 12 carbon atoms or a divalent linking group in which one or more of —CH₂-'s forming a linear or branched alkylene group having 1 to 12 carbon atoms are substituted with —O—, —S—, —NH—, —N(Q)-, or —CO—.

In the present invention, it is preferable that the monofunctional polymerizable liquid crystal compound is a compound having not only a polymerizable group but also two or three groups among a 5-membered ring, a 6-membered ring, a 7-membered ring, and a divalent cyclic group that is formed by fusing the rings (for example, a 1,4-phenylene group or a naphthalene-2,6-diyl group).

Here, examples of the 5-membered ring include a cyclopentene ring, a pyrrole ring, a pyrazole ring, a pyrrolidine ring, a pyrazolidine ring, an imidazolidine ring, an isooxazolidine ring, and an isothiazolidine ring.

Examples of the 6-membered ring include a benzene ring, a pyridine ring, a pyrimidine ring, a piperidine ring, a piperazine ring, a morpholine ring, and a cyclohexene ring.

Examples of the 7-membered ring include a heptamethyleneimine ring, a homopiperazine ring, and a cycloheptene ring.

In addition, these rings and the fused ring may be substituted or unsubstituted. In a case where these rings and the fused ring are substituted, examples of the substituent include the same substituents as the above-described substituents L. Among these, an alkyl group or a halogen atom is preferable.

In addition, in the present invention, from the viewpoint of improving easy alignment of the liquid crystal composition to improve the manufacturing efficiency or the yield of the diffraction element during the manufacturing of the liquid crystal diffraction element having mall angle dependence, it is preferable that the monofunctional polymerizable liquid crystal compound is a compound represented by Formula (II).

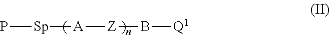

In Formula (II), P represents a polymerizable group.

Q¹ represents a hydrogen atom, a halogen atom, —CN, —NCS, or an alkyl group having 1 to 15 carbon atoms. In a case where Q¹ represents an alkyl group having 1 to 15 carbon atoms, a hydrogen atom in the alkyl group may be substituted with a fluorine atom, and —CH₂— in the alkyl group may be substituted with —O—, —S—, —CQQ-, —SO—, —COO—, —OCO—, —CO—S—, —S—CO—, —O—CO—O—, —CO-NQ-, —NQ-CO—, —CQ=CQ-, —CQ=N—, —N═CQ-, —N═N—, —CQ=N—N═CQ-, or —C≡C—. Q represents a hydrogen atom, a fluorine atom, or an alkyl group having 1 to 10 carbon atoms. In a case where a plurality of Q's are present, the plurality of Q's may be the same as or different from each other.

Sp represents a single bond or a divalent linking group. Sp does not represent a divalent linking group having at least one group selected from the group consisting of an aromatic hydrocarbon ring group, an aromatic heterocyclic group, and an aliphatic hydrocarbon ring group.

n represents an integer of 1 to 5.

Z represents a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR=CR—, —CR=N—, —N═CR—, —N═N—, —CR=N—N═CR—, —CF=CF—, or —C≡C—. R represents a hydrogen atom or an alkyl group having 1 to 10 carbon atoms. In a case where a plurality of R's are present, the plurality of R's may be the same as or different from each other. In a case where n represents 1, Z represents —C≡C—, and in a case where n represents an integer of 2 to 5, a plurality of Z's may be the same as or different from each other and at least one Z represents —C≡C.

A and B each independently represent a 5-membered ring, a 6-membered ring, or a 7-membered ring, or a divalent cyclic group that may have a substituent and is formed by fusing the rings, and at least one of A or B represents a substituted or unsubstituted 1,4-phenylene group. Here, A and B may be each independently substituted with a halogen atom, —CN, —NCS, or an alkyl group having 1 to 8 carbon atoms. In a case where A and B are substituted with an alkyl group having 1 to 8 carbon atoms, a hydrogen atom in the alkyl group may be substituted with a fluorine atom, and —CH₂— in the alkyl group may be substituted with —O—, —S—, —COO—, —SO—, —COO—, —OCO—, —CO—S—, —S—CO—, —O—CO—O—, —CO-NQ-, —NQ-CO—, —CQ=CQ-, —CQ=N—, —N═CQ-, —N═N—, —CQ=N—N═CQ-, or —C≡C—. Q represents a hydrogen atom, a fluorine atom, or an alkyl group having 1 to 5 carbon atoms. In a case where a plurality of Q's are present, the plurality of Q's may be the same as or different from each other. In a case where n represents an integer of 2 to 5, a plurality of A's may be the same as or different from each other.

Here, examples of the polymerizable group represented by P in Formula (II) include the same groups as those described regarding the polymerizable group in the above-described polymerizable liquid crystal compound.

Examples of the divalent linking group in one aspect of Sp include a linear or branched alkylene group having 1 to 12 carbon atoms or a divalent linking group in which one or more of —CH₂-'s forming a linear or branched alkylene group having 1 to 12 carbon atoms are substituted with —O—, —S—, —NH—, —N(Q)-, or —CO—.

In addition, examples of the divalent cyclic group represented by A and B include a 5-membered ring, a 6-membered ring, a 7-membered ring, and a divalent cyclic group that is formed by fusing the rings. Specifically, a 1,4-phenylene group or a naphthalene-2,6-diyl group can be used. Examples of the substituent that may be included in the divalent cyclic group include the same substituents as the above-described substituents L. Among these, an alkyl group or a halogen atom is preferable.

Specific examples of the monofunctional polymerizable liquid crystal compound include compounds shown below.

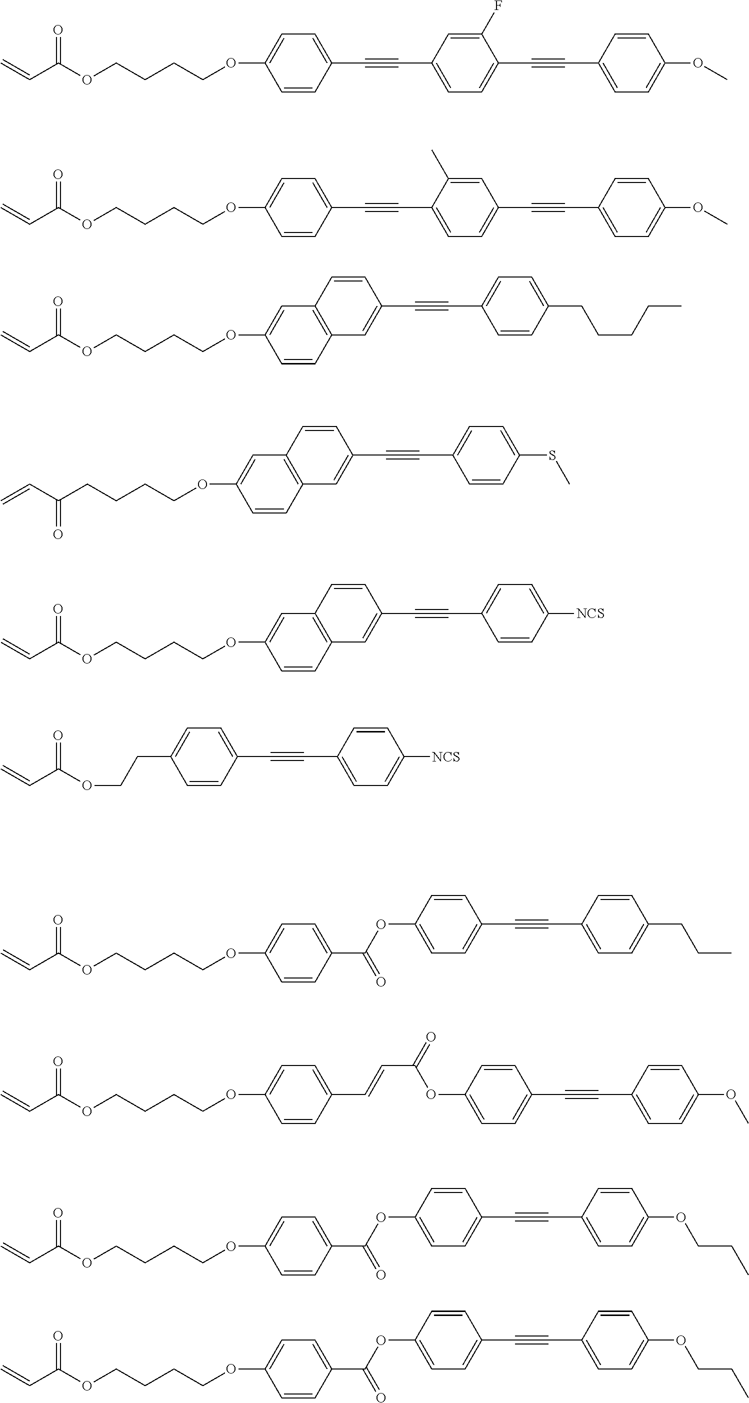

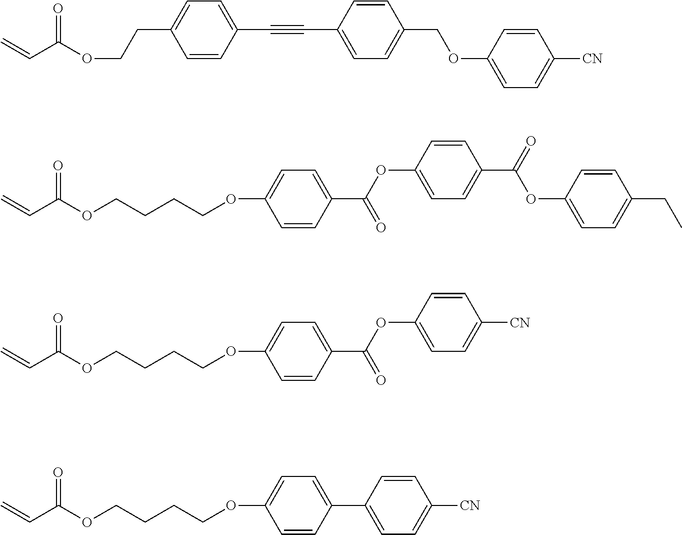

In the present invention, from the viewpoint of further improving the heat resistance of the liquid crystal diffraction element, the content of the monofunctional polymerizable liquid crystal compound is preferably 15% by mass or more, more preferably 15% to 70% by mass, and still more preferably 20% to 60% by mass with respect to the total mass of solid content of the liquid crystal composition.

From the same viewpoint, the content of the monofunctional polymerizable liquid crystal compound is preferably 15% by mass or more, more preferably 15% to 70% by mass, and still more preferably 20% to 60% by mass with respect to the total mass of the monofunctional polymerizable liquid crystal compound and the polyfunctional polymerizable liquid crystal compound.

On the other hand, specific examples of the polyfunctional polymerizable liquid crystal compound include compounds shown below.

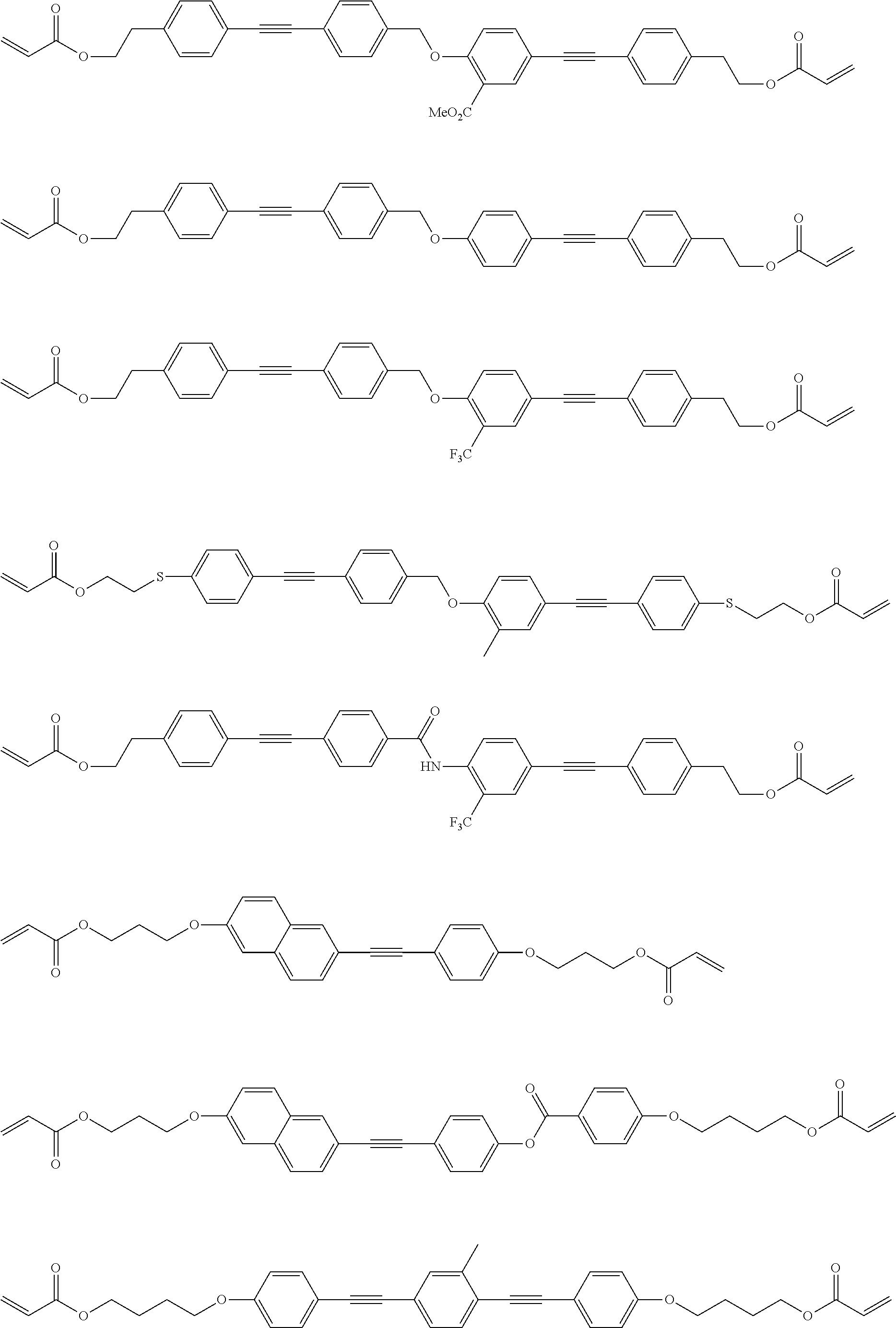

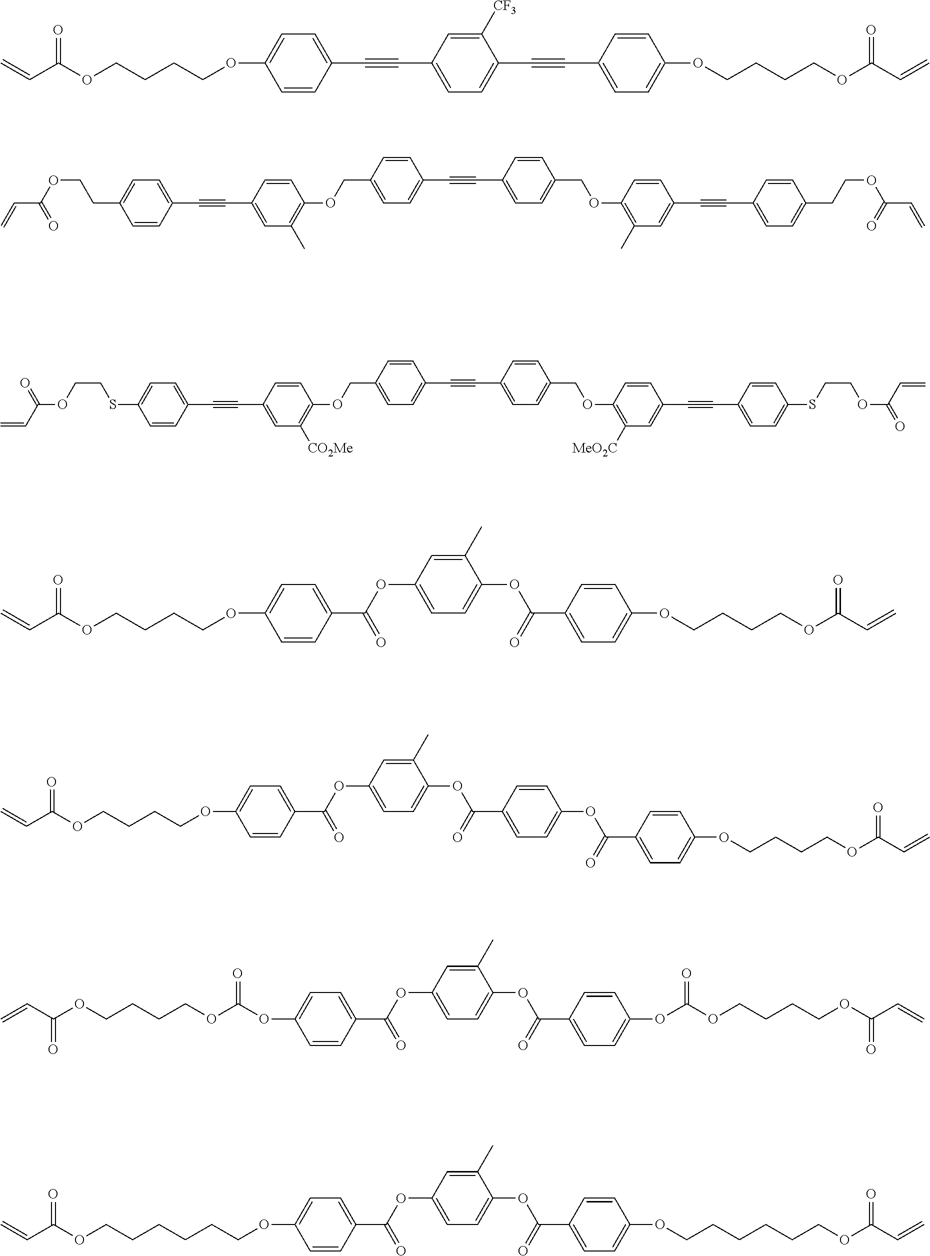

In the present invention, from the viewpoint of widening the temperature range where the liquid crystal composition is aligned or promoting photocuring of the liquid crystal layer, the content of the polyfunctional polymerizable liquid crystal compound is preferably 50% by mass or more, more preferably more than 50% by mass and 90% by mass or less, and still more preferably 60% to 80% by mass with respect to the total mass of the monofunctional polymerizable liquid crystal compound and the polyfunctional polymerizable liquid crystal compound.

In addition, in the present invention, from the viewpoint of widening the temperature range where the liquid crystal composition is aligned or promoting photocuring of the liquid crystal layer, the content of the polymerizable liquid crystal compound (refer to the total content of the monofunctional polymerizable liquid crystal compound and the polyfunctional polymerizable liquid crystal compound; hereinafter, the same applied) is preferably 50% by mass or more, more preferably more than 50% by mass and 98% by mass or less, and still more preferably 60% to 95% by mass with respect to the total mass of solid content of the liquid crystal composition.

### <Surfactant>

The liquid crystal composition may include a surfactant.

Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

The surfactants may be used alone or in combination of two or more kinds.

As the fluorine-based surfactant, a compound described in paragraphs “0082” to “0090” of JP2014-119605A is preferable.

The content of any surfactant in the liquid crystal composition is preferably 0.01% to 10% by mass, more preferably 0.01% to 5% by mass, and still more preferably 0.02% to 1% by mass with respect to the mass of the polymerizable liquid crystal compound.

### <Chiral Compound>

From the viewpoint of improving the wavelength dispersion of the diffraction efficiency, it is preferable that the liquid crystal composition includes a chiral compound (chiral agent).

The chiral agent has a function of inducing a helical structure of a liquid crystal phase. The chiral agent may be selected depending on the purposes because a helical twisted direction and a helical twisting power (HTP) to be induced vary depending on compounds.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a desired twisted alignment corresponding to a luminescence wavelength can be formed by irradiation of an actinic ray or the like through a photomask after coating and alignment, which is preferable. As the photoisomerization group, an isomerization portion of a photochromic compound, an azo group, an azoxy group, or a cinnamoyl group is preferable. Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, and JP2003-313292A.

The content of any chiral agent in the liquid crystal composition is preferably 0.01% to 200 mol % and more preferably 1% to 30 mol % with respect to the content molar amount of the polymerizable liquid crystal compound.

### <Polymerization Initiator>

It is preferable that the liquid crystal composition includes a polymerization initiator. In an aspect where a polymerization reaction progresses with ultraviolet irradiation, it is preferable that the polymerization initiator to be used is a photopolymerization initiator which initiates a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of any photopolymerization initiator is preferably 0.1% to 20% by mass and more preferably 0.5% to 12% by mass with respect to the mass of the rod-like liquid crystal compound.

### <Crosslinking Agent>

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris [3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. The crosslinking agents may be used alone or in combination of two or more kinds.

The content of any crosslinking agent is preferably 3% to 20% by mass and more preferably 5% to 15% by mass with respect to the solid content mass of the liquid crystal composition. In a case where the content of the crosslinking agent is in the above-described range, the durability of the prepared optical element is improved.

### <Other Additives>

Optionally, a polymerization inhibitor, an antioxidant, an ultraviolet absorber, a light stabilizer, a coloring material, metal oxide fine particles, or the like can be added to the liquid crystal composition in a range where optical performance and the like do not deteriorate.

It is preferable that the liquid crystal composition is used as a liquid during the formation of the optically-anisotropic layer.

The liquid crystal composition may include a solvent. The solvent is not particularly limited and can be appropriately selected depending on the purpose. An organic solvent is preferable.

Examples of the organic solvent include a ketone, an alkyl halide, an amide, a sulfoxide, a heterocyclic compound, a hydrocarbon, an ester, and an ether. The organic solvents may be used alone or in combination of two or more kinds. Among these, a ketone is preferable in consideration of an environmental burden.

The liquid crystal composition may be prepared using a well-known method in the related art. In addition, for the application of the liquid crystal composition, various well-known methods used for applying liquid, for example, bar coating, gravure coating, or spray coating can be used.

In addition, the coating thickness of the liquid crystal composition that is required to obtain an optically-anisotropic layer having a desired thickness may be appropriately set depending on the liquid crystal composition and the like.

The thickness of the coating film obtained by applying the liquid crystal composition is preferably 0.1 μm or more, more preferably 0.5 μm or more, and still more preferably 1.5 μm or more. The upper limit is not particularly limited and is preferably 20 μm or less and more preferably 15 or μm or less.

The coating film obtained by applying the liquid crystal composition is optionally dried and/or heated and then cured. The curing treatment may be performed using a well-known method such as photopolymerization or thermal polymerization. For the polymerization, photopolymerization is preferable. Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

By curing the liquid crystal composition, the polymerizable liquid crystal compound in the liquid crystal composition is immobilized in a state (liquid crystal alignment pattern) where the liquid crystal compound is aligned along the alignment pattern of the alignment film. As a result, an optically-anisotropic layer having a liquid crystal alignment pattern in which an orientation of an optical axis derived from the polymerizable liquid crystal compound changes while continuously rotating in at least one in-plane direction is formed.

When the optically-anisotropic layer is completed, the polymerizable liquid crystal compound does not have to exhibit liquid crystallinity. Specifically, the molecular weight of the polymerizable liquid crystal compound may be increased by a curing reaction such that the liquid crystallinity thereof is lost.

In the optical elements shown in FIGS. 1 and 2, the orientation of the optical axis 30A of the polymerizable liquid crystal compound 30 in the liquid crystal alignment pattern of the optically-anisotropic layer 16 continuously rotates only in the arrow X direction.

However, the present invention is not limited thereto, and various configurations can be used as long as the orientation of the optical axis 30A of the polymerizable liquid crystal compound 30 in the optically-anisotropic layer continuously rotates in the one direction.

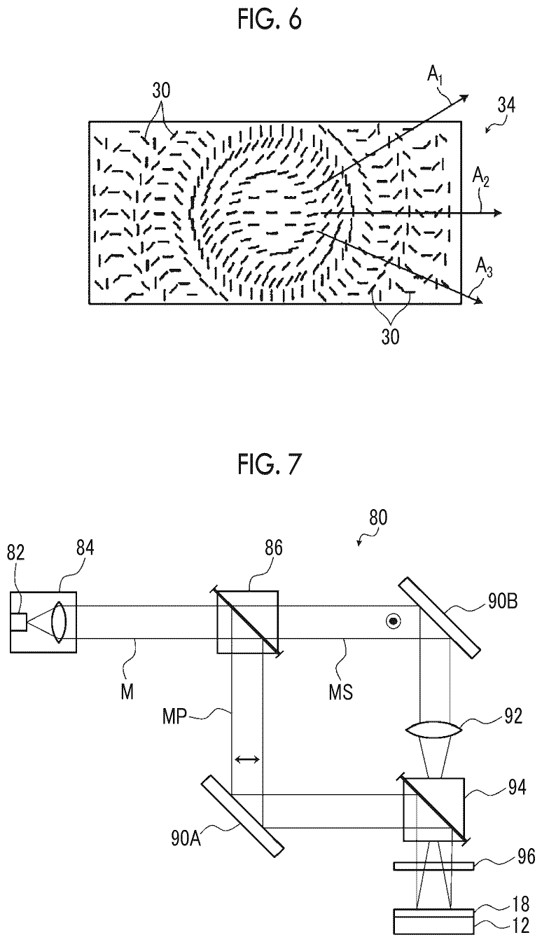

For example, an optically-anisotropic layer 34 conceptually shown in a plan view of FIG. 6 can be used, in which a liquid crystal alignment pattern is a concentric circular pattern having a concentric circular shape where the one direction in which the orientation of the optical axis of the polymerizable liquid crystal compound 30 changes while continuously rotating moves from an inner side toward an outer side. In other words, the liquid crystal alignment pattern of the optically-anisotropic layer 34 shown in FIG. 6 is a liquid crystal alignment pattern where the one direction in which the orientation of the optical axis of the polymerizable liquid crystal compound 30 changes while continuously rotating is provided in a radial shape from the center of the optically-anisotropic layer 34.

FIG. 6 shows only the polymerizable liquid crystal compound 30 of the surface of the photo-alignment film as in FIG. 2. However, as shown in FIG. 1, the optically-anisotropic layer 34 has the structure in which the polymerizable liquid crystal compound 30 on the surface of the photo-alignment film is laminated as described above.

In the optically-anisotropic layer 34 shown in FIG. 6, the optical axis (not shown) of the polymerizable liquid crystal compound 30 is a longitudinal direction of the polymerizable liquid crystal compound 30.

In the optically-anisotropic layer 34, the orientation of the optical axis of the polymerizable liquid crystal compound 30 changes while continuously rotating in a direction in which a large number of optical axes move to the outer side from the center of the optically-anisotropic layer 34, for example, a direction indicated by an arrow A1, a direction indicated by an arrow A2, a direction indicated by an arrow A3, or . . . .

In circularly polarized light incident into the optically-anisotropic layer 34 having the above-described liquid crystal alignment pattern, an absolute phase changes depending on individual local regions having different orientations of optical axes of the polymerizable liquid crystal compound 30. In this case, the amount of change in absolute phase varies depending on the orientations of the optical axes of the polymerizable liquid crystal compound 30 into which circularly polarized light is incident.

This way, in the optically-anisotropic layer 34 having the concentric circular liquid crystal alignment pattern, that is, the liquid crystal alignment pattern in which the optical axis changes while continuously rotating in a radial shape, transmission of incidence light can be allowed as diverging light or converging light depending on the rotation direction of the optical axis of the polymerizable liquid crystal compound 30 and the direction of circularly polarized light to be incident.

That is, by setting the liquid crystal alignment pattern of the optically-anisotropic layer in a concentric circular shape, the optical element according to the embodiment of the present invention exhibits, for example, a function as a convex lens or a concave lens.

FIG. 7 conceptually shows an example of an exposure device that forms the concentric circular alignment pattern in the photo-alignment film.

An exposure device 80 includes: a light source 84 that includes a laser 82; a polarization beam splitter 86 that divides the laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P polarized light MP that is split by the polarization beam splitter 86 is reflected from the mirror 90A to be incident into the polarization beam splitter 94. On the other hand, the S polarized light MS that is split by the polarization beam splitter 86 is reflected from the mirror 90B and is collected by the lens 92 to be incident into the polarization beam splitter 94.

The P polarized light MP and the S polarized light MS are multiplexed by the polarization beam splitter 94, are converted into right circularly polarized light and left circularly polarized light by the λ/4 plate 96 depending on the polarization direction, and are incident into the coating film (photo-alignment film precursor) 18 on the support 12.

Here, due to interference between the right circularly polarized light and the left circularly polarized light, the polarization state of light with which the coating film 18 is irradiated periodically changes according to interference fringes. The intersecting angle between the right circularly polarized light and the left circularly polarized light changes from the inside to the outside of the concentric circle. Therefore, an exposure pattern in which the pitch changes from the inner side to the outer side can be obtained. As a result, in the coating film 18, a concentric circular alignment pattern in which the alignment state periodically changes can be obtained.

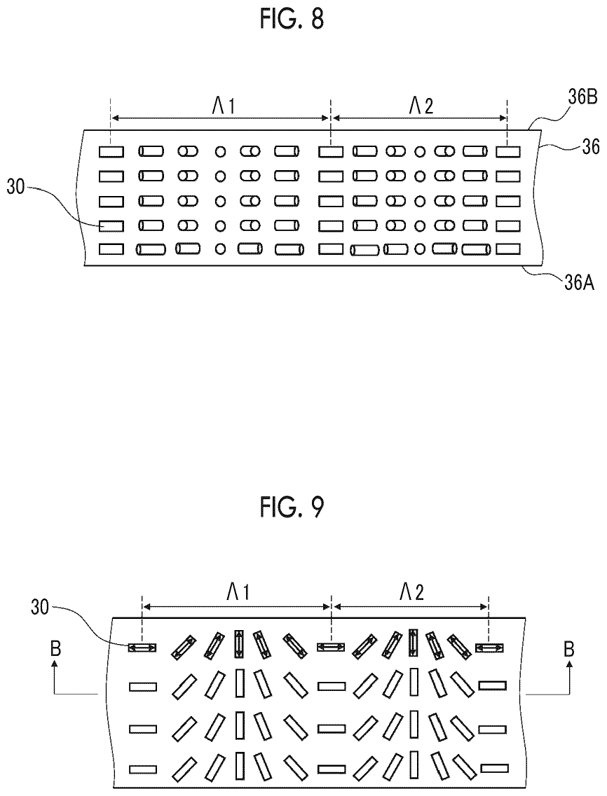

In the optically-anisotropic layer 16 shown in FIGS. 1 and 2, the aspect where the length of the single period of the liquid crystal alignment pattern is fixed is described. As shown in FIGS. 8 and 9, an aspect where the length of the single period in the liquid crystal alignment pattern gradually decreases in the one direction in which the orientation of the optical axis changes while continuously rotating in the liquid crystal alignment pattern may be adopted. By gradually decreasing the single period Λ of the liquid crystal alignment pattern, an optically-anisotropic layer that allows transmission of light to be collected can be obtained.

FIG. 8 is a cross-sectional view of an optically-anisotropic layer 36 taken in the direction in which the liquid crystal alignment pattern extends. FIG. 9 is a plan view showing another surface 36B of the optically-anisotropic layer 36 of FIG. 8. FIG. 8 is a cross-sectional view taken along line B-B in FIG. 9.

An orientation (direction) of the optical axis 30A of the polymerizable liquid crystal compound 30 shown in FIG. 8 to be most adjacent to one surface 36A of the optically-anisotropic layer 36 represents a direction of the optical axis 30A of the polymerizable liquid crystal compound 30 on the one surface 36A. In addition, an orientation of the optical axis 30A of the polymerizable liquid crystal compound 30 shown in FIG. 8 to be most adjacent to the other surface 36B of the optically-anisotropic layer 36 represents an orientation of the optical axis 30A of the polymerizable liquid crystal compound 30 on the other surface 36B.

The optically-anisotropic layer 36 shown in FIGS. 8 and 9 has the same configuration as the optically-anisotropic layer 16 shown in FIGS. 6 and 7, except that the lengths of the single periods of the liquid crystal alignment patterns are different. In the optically-anisotropic layer 36, the length of the single period of the liquid crystal alignment pattern gradually decreases. More specifically, as shown in FIGS. 8 and 9, a single period Λ2 of the liquid crystal alignment pattern on the right side in the drawing is shorter than a single period Λ1 of the liquid crystal alignment pattern on the left side in the drawing.

Accordingly the liquid crystal diffraction element according to the embodiment of the present invention is suitably applicable to various optical devices where light having the same wavelength is required to be diffracted at different angles irrespective of incidence positions, for example, a lens element in a head-mounted display (HMD) for virtual reality (VR) or a lens element that is used in combination with a refractive lens to improve color break.

### [Optical Element]

An optical element according to a first aspect of the present invention comprises: the above-described liquid crystal diffraction element according to the embodiment of the present invention; and a circularly polarizing plate.

In addition, in a case where the above-described circularly polarizing plate includes a retardation plate and a polarizer, it is preferable that the optical element according to the first aspect of the present invention is an optical element where the liquid crystal diffraction element, the retardation plate, and the polarizer are provided in this order.

Here, in a case where a part of light is not diffracted by the liquid crystal diffraction element, a part of right circularly polarized light incident into the liquid crystal diffraction element transmits through the liquid crystal diffraction element without being diffracted. In a case where the circularly polarizing plate is not provided, the right circularly polarized light that is not diffracted by the liquid crystal diffraction element linearly travels as it is. The right circularly polarized light that linearly travels is unnecessary depending on applications, which decreases the performance.

On the other hand, in the optical element according to the first aspect of the present invention, the right circularly polarized light (that is, zero-order light) that is not diffracted by the liquid crystal diffraction element is converted into linearly polarized light having a direction orthogonal to the left circularly polarized light (first-order light) that is incident into and diffracted by the retardation plate of the circularly polarizing plate, and is incident into the linearly polarizing plate and absorbed. That is, the right circularly polarized light that is not diffracted by the liquid crystal diffraction element is absorbed by the circularly polarizing plate. Accordingly, transmission of the desired first-order light of left circularly polarized light is allowed, and the right circularly polarized light that is not diffracted can be reduced. Therefore, a decrease in performance by unnecessary light (zero-order light) can be suppressed.

The optical element according to the first aspect of the present invention may be used in combination with another optical element provided downstream of the circularly polarizing plate.

For example, a retardation plate may be disposed downstream of the circularly polarizing plate. Specifically, a configuration where linearly polarized light transmitted through the circularly polarizing plate is converted into circularly polarized light, elliptically polarized light, and linearly polarized light having a different polarization direction by the retardation plate that is disposed downstream of the circularly polarizing plate can also be preferably used.

In addition, instead of the retardation plate, a depolarization layer that depolarizes the polarization state of light in at least a part of a wavelength range may be used. Examples of the depolarization layer include a high retardation film and a light scattering layer. By controlling the polarization state of the light emitted from the circularly polarizing plate, the polarization state can be adjusted depending on applications. The high retardation film is, for example, a film having an in-plane phase difference of 3000 nm or more.

In another example, an optical element that is provided downstream of the circularly polarizing plate to deflect light may be used. For example, by disposing the optical element such as a lens that deflects light downstream of the circularly polarizing plate, the traveling direction of light emitted from the circularly polarizing plate can be changed. By controlling the deflection direction of the light emitted from the circularly polarizing plate, the emission direction of light can be adjusted depending on applications.

An optical element according to a second aspect of the present invention comprises: the above-described liquid crystal diffraction element according to the embodiment of the present invention; a silicon oxide layer, and a support in this order.

Here, examples of the support include the above-described examples.

In addition, the silicon oxide layer is not particularly limited as long as it mainly includes silicon oxide, and the content of the silicon oxide in the silicon oxide layer is preferably 80% by mass, more preferably 90% by mass, and still more preferably 100% by mass, that is, a configuration where the silicon oxide layer consists of silicon oxide.

The silicon oxide layer can act as an extremely thin (for example, 10 to 50 nm) adhesive layer. Therefore, the optical element according to the second aspect of the present invention can reduce light leak caused by the effect of the thickness of the adhesive layer, and thus can be suitably used in a case where an optical member such as a light guide plate is used as the support.

<Combination with Phase Modulation Element>

An optical element according to a third aspect of the present invention includes: the above-described liquid crystal diffraction element according to the embodiment of the present invention or the above-described optical element according to the first or second aspect of the present invention; and a phase modulation element.

For example, by using a switchable half waveplate (switchable λ/2 plate) that can modulate a phase difference with a voltage as disclosed in U.S. Ser. No. 10/379,419B1 and the liquid crystal diffraction element according to the embodiment of the present invention (used as a passive element) in combination, a focus tunable lens having a high diffraction efficiency irrespective of light incidence positions in a plane of the element can be realized. In addition, by using plural sets of the phase modulation elements and the liquid crystal diffraction elements in combination, a plurality of adjustable focal lengths can increase.

By using this focus tunable lens for augmented reality (AR) glasses or VR glasses, the focal position of a display image of an HMD can be freely changed.

<Combination with Lens>

A configuration where the liquid crystal diffraction element according to the embodiment of the present invention or the above-described optical element according to any one of the first to third aspects of the present invention is used in combination with another lens element can also be preferably used.

For example, by using the liquid crystal diffraction element according to the embodiment of the present invention in combination with a Fresnel lens disclosed in SID 2020 DIGEST, 40-4, pp. 579-582, chromatic aberration of the lens can be improved with a high diffraction efficiency irrespective of light incidence positions in a plane of the element. The lens to be used in combination is not particularly limited, and a combination with a refractive index lens or a pancake lens disclosed in U.S. Pat. No. 3,443,858A, Optics Express, Vol. 29, No 4/15 Feb. 2021, or the like can also be suitably used.

By using an optical system including the lens and the liquid crystal diffraction element in combination for AR glasses or VR glasses, color shift (chromatic aberration of the lens) of a display image of the HMD can be improved.

<Combination with Light Guide Plate>

A configuration where the liquid crystal diffraction element according to the embodiment of the present invention or the above-described optical element according to any one of the first to third aspects of the present invention is used in combination with a light guide plate can also be preferably used.

For example, in a combination of a light guide plate and a lens disclosed in Proc. of SPIE Vol. 11062, Digital Optical Technologies 2019, 110620J (16 Jul. 2019), by using the liquid crystal diffraction element according to the embodiment of the present invention as the lens, the focal position of a display image emitted from the light guide plate can be changed. This way, by using the liquid crystal diffraction element in combination with the light guide plate, the focal position of a display image of an HMD such as AR glasses or VR glasses can be adjusted. For use in AR glasses, by using the liquid crystal diffraction element according to the embodiment of the present invention as positive and negative lenses between which a light guide plate is interposed as disclosed in Proc. of SPIE Vol. 11062, Digital Optical Technologies 2019, 110620J (16 Jul. 2019), both of an actual scene and a display image output from the light guide plate can be observed without distortion.

<Combination with Image Display Apparatus>

The liquid crystal diffraction element according to the embodiment of the present invention or the above-described optical element according to any one of the first to third aspects of the present invention can also be preferably used in combination with an image display apparatus.

For example, by using the liquid crystal diffraction element (used as a diffractive deflection film) and an image display apparatus disclosed in Crystals 2021, 11, 107 in combination, a brightness distribution of emitted light from the image display apparatus can be adjusted.

By using the image display unit combined with the image display apparatus, a brightness distribution of an HMD such as AR glasses or VR glasses can be suitably adjusted.

<Combination with Beam Steering>

The liquid crystal diffraction element according to the embodiment of the present invention or the above-described optical element according to any one of the first to third aspects of the present invention can also be preferably used in combination with an image deflection element (beam steering).

For example, by using the liquid crystal diffraction element according to the embodiment of the present invention as a diffraction element of a light deflection element disclosed in WO2019/189675A, the deflection angle of emitted light can be increased with a high diffraction efficiency.

By using the liquid crystal diffraction element in combination with the light deflection element (beam steering), a light irradiation angle of a distance-measuring sensor such as light detection and ranging (LiDAR) can be suitably widened.

<Combination with Sensor>

The liquid crystal diffraction element according to the embodiment of the present invention or the above-described optical element according to any one of the first to third aspects of the present invention can also be preferably used in combination with a sensor.

Examples of the sensor include a sensor for tracking an object or for a distance measurement system using infrared light.

Hereinabove, the liquid crystal diffraction element, the optical element, the image display unit, the head-mounted display, the beam steering, and the sensor according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

### [Preparation of Liquid Crystal Diffraction Element]

### <Support>

A glass substrate was used as the support.

### <Formation of Alignment Film>

The following coating liquid for forming an alignment film was applied to the support by spin coating. The support on which the coating film of the coating liquid for forming an alignment film was formed was dried using a hot plate at 60° C. for 60 seconds. As a result, an alignment film was formed.

Coating Liquid for Forming Alignment Film

| | |
|---|---|
| The following material B for photo-alignment | 1.00 part by mass |
| Water | 16.00 parts by mass |
| Butoxyethanol | 42.00 parts by mass |
| Propylene glycol monomethyl ether | 42.00 parts by mass |

### Material B for Photo-Alignment

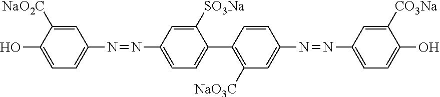

### <Exposure of Alignment Film>

The alignment film was exposed using the exposure device shown in FIG. 3 to form an alignment film P-1 having an alignment pattern.

In the exposure device, a laser that emits laser light having a wavelength (325 nm) was used as the laser. The exposure amount of the interference light was 1000 mJ/cm².

### <Formation of Optically-Anisotropic Layer>

As a liquid crystal composition forming a first optically-anisotropic layer, the following composition B-1 was prepared.

Composition B-1

| | |
|---|---|
| The following polyfunctional polymerizable | 80.00 parts by mass |
| liquid crystal compound A1-1 | |
| The following monofunctional polymerizable | 20.00 parts by mass |
| liquid crystal compound A2-4 | |
| Polymerization initiator (Omnirad-819) | 3.00 parts by mass |
| The following leveling agent T-1 | 0.08 parts by mass |
| Methyl ethyl keton | 1050.00 parts by mass |

### Polyfunctional Polymerizable Liquid Crystal Compound A1-1

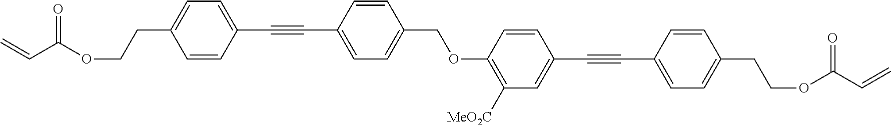 [SMILES: C=CC(=O)OCCc1ccc(C#Cc2ccc(COc3ccc(C#Cc4ccc(CCOC(=O)C=C)cc4)cc3C(=O)OC)cc2)cc1]

Monofunctional polymerizable liquid crystal compound A2-4

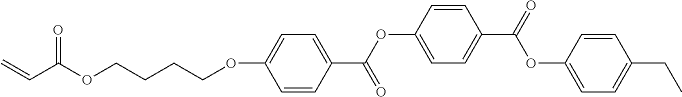 [SMILES: C=CC(=O)OCCCCOc1ccc(C(=O)Oc2ccc(C(=O)Oc3ccc(CC)cc3)cc2)cc1]

### Leveling Agent T-1

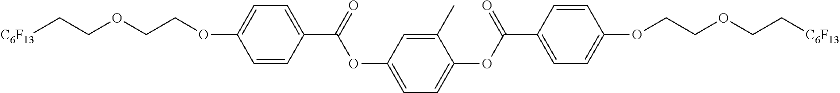

The optically-anisotropic layer was formed by applying multiple layers of the composition B-1 to the alignment film P-1.

Here, the application of the multiple layers refers to repetition of the following processes including: preparing a first liquid crystal immobilized layer by applying the composition B-1 for forming the first layer to the alignment film, heating the composition B-1, and irradiating the composition B-1 with ultraviolet light for curing; and preparing a second or subsequent liquid crystal immobilized layer by applying the composition B-1 for forming the second or subsequent layer to the formed liquid crystal immobilized layer, heating the composition B-1, and irradiating the composition B-1 with ultraviolet light for curing as described above.

Even in a case where the liquid crystal layer was formed by the application of the multiple layers such that the total thickness of the optically-anisotropic layer was large, the alignment direction of the alignment film was reflected from a lower surface of the optically-anisotropic layer to an upper surface thereof.

First, regarding the first liquid crystal layer, the following composition B-1 was applied to the alignment film P-1 to form a coating film, the coating film was heated to 80° C. using a hot plate, the coating film was irradiated with ultraviolet light having a wavelength of 365 nm at an irradiation amount of 300 mJ/cm² using a high-pressure mercury lamp in a nitrogen atmosphere. As a result, the alignment of the liquid crystal compound was immobilized.

Next, regarding the second or subsequent liquid crystal immobilized layer, the composition was applied to the first liquid crystal layer, and the applied composition was heated and irradiated with ultraviolet light for curing under the same conditions as described above. As a result, a liquid crystal immobilized layer was prepared. This way, by repeating the application multiple times until the total thickness reached a desired film thickness, an optically-anisotropic layer was formed, and a liquid crystal diffraction element was prepared.

A complex refractive index Δn of the cured layer of a liquid crystal composition B-1 was obtained by applying the liquid crystal composition B-1 a support with an alignment film for retardation measurement that was prepared separately, aligning the director of the liquid crystal compound to be parallel to the substrate, irradiating the liquid crystal compound with ultraviolet irradiation for immobilization to obtain a liquid crystal immobilized layer (cured layer), and measuring the retardation value of the liquid crystal immobilized layer. The retardation value at a wavelength of 550 nm was measured using Axoscan (manufactured by Axo metrix Inc.).

The optically-anisotropic layer was prepared by adjusting the film thickness such that the retardation value was finally 275 nm. In addition, it was verified using a polarization microscope that the optically-anisotropic layer had a periodically aligned surface. In the liquid crystal alignment pattern of the optically-anisotropic layer, the single period over which the optical axis of the polymerizable liquid crystal compound rotated by 180° was 1.0 μm.

### Examples 2 to 11 and Comparative Examples 1 to 3

Optically-anisotropic layers were formed and liquid crystal diffraction elements were prepared using the same method as that of Example 1, except that, regarding the composition B-1 used for forming the optically-anisotropic layer, the kinds and the mixing amounts of the polyfunctional polymerizable liquid crystal compound and the monofunctional polymerizable liquid crystal compound were changed as shown in Tables 1 and 2 below. Here, regarding Comparative Example 3, an optically-anisotropic layer was formed by adjusting the irradiation amount for immobilizing the alignment of the polymerizable liquid crystal compound to be half of that of Example 1, and a liquid crystal diffraction element was prepared.

### [Evaluation]

The prepared liquid crystal diffraction element was evaluated using the following two methods. The results are shown in Tables 1 and 2 below. The evaluations A, B, and C are suitable as the liquid crystal diffraction element, but the evaluation D is not suitable as the liquid crystal diffraction element.

### [Diffraction Test]

In a case where light was incident into the liquid crystal diffraction element from the front (direction with an angle of 0° with respect to the normal line) and from an oblique direction (direction with an angle of 20° with respect to the normal line), the diffraction efficiencies of emitted light were evaluated.

Specifically, laser light having an output central wavelength of 532 nm was emitted from the light source to be incident into the prepared liquid crystal diffraction element. In the emitted light from the liquid crystal diffraction element, the intensities of diffracted light (first-order light) diffracted in a desired direction, zero-order light (emitted in the same direction as incidence light) emitted in the other directions, and negative first-order light (light diffracted in a −θ direction in a case where the diffraction angle of first-order light with respect to zero-order light was represented by θ) were measured using a photodetector, and the diffraction efficiency at each of the wavelengths was calculated from the following expression.

Diffraction Efficiency=First-Order Light/(First-Order Light+Zero-Order Light+(Negative First-Order Light))

Regarding the irradiation of laser light into the prepared liquid crystal diffraction element, the laser light was vertically incident into a circularly polarizing plate corresponding to the wavelength of the laser light to be converted into circularly polarized light, and the circularly polarized light was incident.

In a case where the diffraction efficiency of the prepared liquid crystal diffraction element in the front direction was represented by 1, the diffraction efficiency in the oblique direction was calculated from the following expression.

As the oblique diffraction index approaches 1, the angle dependence of diffraction efficiency is excellent. A case where the oblique diffraction index was 0.95 or more was evaluated as A, a case where the oblique diffraction index was 0.9 or more was evaluated as B, a case where the oblique diffraction index was 0.8 or more was evaluated as C, and a case where the oblique diffraction index was less than 0.8 was evaluated as D.

Oblique Diffraction Index=Oblique Diffraction Efficiency/Front Diffraction Efficiency

### [Heat Resistance Test]

In a case where a heat treatment was performed on the prepared liquid crystal diffraction element at 120° C. for 1 hour, a rate of change in the diffraction efficiency of the front direction before and after the heat treatment was calculated from the following expression.

As the rate of thermal change approaches 1, the heat resistance of the diffraction element is excellent. A case where the rate of thermal change was 0.97 or more was evaluated as A, a case where the rate of thermal change was 0.95 or more was evaluated as B, a case where the rate of thermal change was 0.9 or more was evaluated as C, and a case where the rate of thermal change was less than 0.9 was evaluated as D.

$$Rate of Thermal Change = Diffraction Efficiency of Front Direction after Treatment at 120 ° C . / \\ Diffraction Efficiency of Front Direction before Treatment at 120 ° C .$$

TABLE 1

| | Example 1 | Example 2 | Example 3 | Example 4 | Example 5 | Example 6 | Example 7 |
|---|---|---|---|---|---|---|---|
| Polyfunctional Polymerizable | 80 | 80 | 80 | 80 | | | |
| Liquid Crystal Compound A1-1 | | | | | | | |
| Polyfunctional Polymerizable | | | | | 80 | | |
| Liquid Crystal Compound A1-2 | | | | | | | |
| Polyfunctional Polymerizable | | | | | | 60 | |
| Liquid Crystal Compound A1-3 | | | | | | | |
| Polyfunctional Polymerizable | | | | | | 20 | 60 |
| Liquid Crystal Compound A1-4 | | | | | | | |
| Monofunctional Polymerizable | | 20 | | | | | |
| Liquid Crystal Compound A2-1 | | | | | | | |
| Monofunctional Polymerizable | | | 20 | | | 20 | 20 |
| Liquid Crystal Compound A2-2 | | | | | | | |
| Monofunctional Polymerizable | | | | | | | 20 |
| Liquid Crystal Compound A2-3 | | | | | | | |
| Monofunctional Polymerizable | 20 | | | | | | |
| Liquid Crystal Compound A2-4 | | | | | | | |
| Monofunctional Polymerizable | | | | 20 | 20 | | |
| Liquid Crystal Compound A2-5 | | | | | | | |
| Expression (1): A/M (mg⁻¹) | 0.83 | 1.10 | 0.97 | 0.83 | 0.96 | 0.59 | 0.40 |
| Expression (2): A/M (mg⁻¹) | 0.31 | 0.31 | 0.28 | 0.31 | 0.33 | 0.40 | 0.32 |
| Diffraction Test | A | A | A | A | A | B | C |
| Heat Resistance Test | A | A | A | A | A | A | A |

TABLE 2

| | Example | Example | Example | Example | Comparative | Comparative | Comparative |
|---|---|---|---|---|---|---|---|
| | 8 | 9 | 10 | 11 | Example 1 | Example 2 | Example 3 |
| Polyfunctional Polymerizable | | | | 80 | 5 | | |
| Liquid Crystal Compound A1-1 | | | | | | | |
| Polyfunctional Polymerizable | 20 | 60 | | | | | 80 |
| Liquid Crystal Compound A1-2 | | | | | | | |
| Polyfunctional Polymerizable | | | 40 | | | 80 | |
| Liquid Crystal Compound A1-3 | | | | | | | |
| Polyfunctional Polymerizable | 20 | 20 | 20 | 10 | 95 | 20 | |
| Liquid Crystal Compound A1-4 | | | | | | | |
| Monofunctional Polymerizable | 30 | 20 | | | | | |
| Liquid Crystal Compound A2-1 | | | | | | | |
| Monofunctional Polymerizable | | | 40 | | | | |
| Liquid Crystal Compound A2-2 | | | | | | | |
| Monofunctional Polymerizable | 30 | | | | | | |
| Liquid Crystal Compound A2-3 | | | | | | | |
| Monofunctional Polymerizable | | | | 10 | | | 20 |
| Liquid Crystal Compound A2-4 | | | | | | | |
| Monofunctional Polymerizable | | | | | | | |
| Liquid Crystal Compound A2-5 | | | | | | | |
| Expression (1): A/M (mg⁻¹) | 0.97 | 1.00 | 0.61 | 0.83 | 0.14 | 0.58 | 0.96 |
| Expression (2): A/M (mg⁻¹) | 0.31 | 0.42 | 0.34 | 0.37 | 0.49 | 0.60 | 0.69 |
| Diffraction Test | A | A | B | A | D | B | A |
| Heat Resistance Test | A | A | A | B | D | D | D |

Structures of the polyfunctional polymerizable liquid crystal compounds A1-1 to A1-4 and the monofunctional polymerizable liquid crystal compounds A2-1 to A2-5 shown in Tables 1 and 2 are as follows.

Polyfunctional Polymerizable Liquid Crystal Compound A1-1

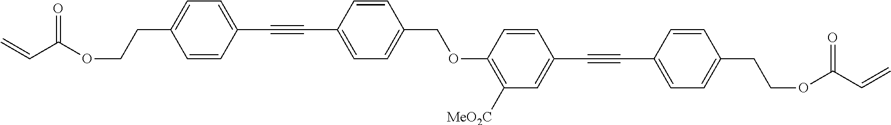 [SMILES: C=CC(=O)OCCc1ccc(C#Cc2ccc(COc3ccc(C#Cc4ccc(CCOC(=O)C=C)cc4)cc3C(=O)OC)cc2)cc1]

### Polyfunctional Polymerizable Liquid Crystal Compound A1-2

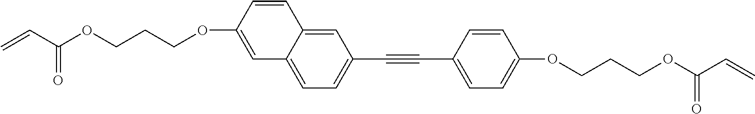 [SMILES: C=CC(=O)OCCCOc1ccc(C#Cc2ccc3cc(OCCCOC(=O)C=C)ccc3c2)cc1]

### Polyfunctional Polymerizable Liquid Crystal Compound A1-3

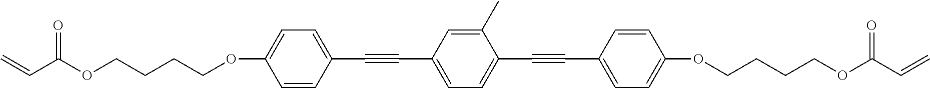 [SMILES: C=CC(=O)OCCCCOc1ccc(C#Cc2ccc(C#Cc3ccc(OCCCCOC(=O)C=C)cc3)c(C)c2)cc1]

### Polyfunctional Polymerizable Liquid Crystal Compound A1-4

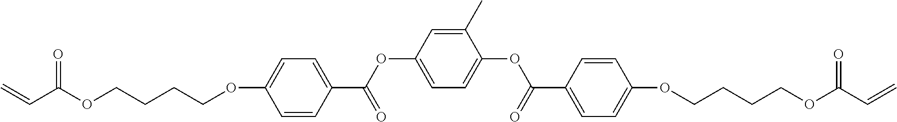 [SMILES: C=CC(=O)OCCCCOc1ccc(C(=O)Oc2ccc(OC(=O)c3ccc(OCCCCOC(=O)C=C)cc3)c(C)c2)cc1]

### Monofunctional Polymerizable Liquid Crystal Compound A2-1

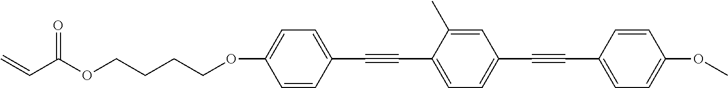 [SMILES: C=CC(=O)OCCCCOc1ccc(C#Cc2ccc(C#Cc3ccc(OC)cc3)cc2C)cc1]

### Monofunctional Polymerizable Liquid Crystal Compound A2-2

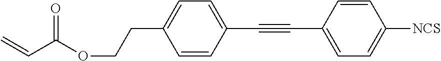

### Monofunctional Polymerizable Liquid Crystal Compound A2-3

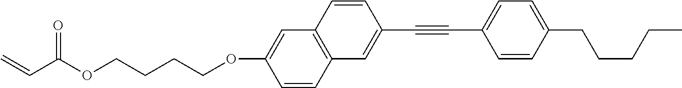 [SMILES: C=CC(=O)OCCCCOc1ccc2cc(C#Cc3ccc(CCCCC)cc3)ccc2c1]

### Monofunctional Polymerizable Liquid Crystal Compound A2-4

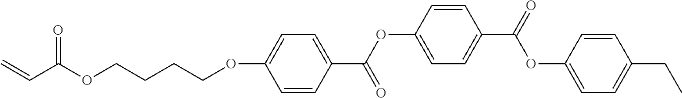 [SMILES: C=CC(=O)OCCCCOc1ccc(C(=O)Oc2ccc(C(=O)Oc3ccc(CC)cc3)cc2)cc1]

### Monofunctional Polymerizable Liquid Crystal Compound A2-5

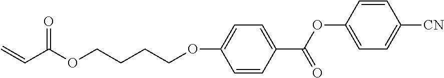 [SMILES: C=CC(=O)OCCCCOc1ccc(C(=O)Oc2ccc(C#N)cc2)cc1]

It was found from the results of Tables 1 and 2 that, in the liquid crystal diffraction element including the optically-anisotropic layer that was formed without mixing the monofunctional polymerizable liquid crystal compound with the liquid crystal composition and did not satisfy Expression (1), the angle dependence of diffraction efficiency was large, and the heat resistance also deteriorated (Comparative Example 1).

In addition, it was found that, in the liquid crystal diffraction element including the optically-anisotropic layer that was formed without mixing the monofunctional polymerizable liquid crystal compound with the liquid crystal composition and did not satisfy Expression (2), the heat resistance deteriorated (Comparative Example 2).

In addition, it was found that, in the liquid crystal diffraction element including the optically-anisotropic layer where the irradiation amount for immobilizing the alignment of the polymerizable liquid crystal compound was adjusted and Expression (2) was not satisfied, the heat resistance deteriorated (Comparative Example 2).

On the other hand, it was found that, in the liquid crystal diffraction element including the optically-anisotropic layer that was formed by mixing the monofunctional polymerizable liquid crystal compound with the liquid crystal composition and satisfied both of Expressions (1) and (2), the angle dependence of diffraction efficiency was small, and the heat resistance was also excellent (Examples 1 to 11).

In particular, it was found from a comparison between Examples 1 to 10 that, in the liquid crystal diffraction element including the optically-anisotropic layer that satisfied Expression (3), the angle dependence of diffraction efficiency was smaller.

In addition, it was found from a comparison between Examples 1 and 11 that, in a case where the content of the monofunctional polymerizable liquid crystal compound is 15% by mass or more with respect to the total mass of solid content of the liquid crystal composition, the heat resistance of the liquid crystal diffraction element is further improved.

### Example 31

### [Preparation of Liquid Crystal Diffraction Element]

### <Formation of Optically-Anisotropic Layer>

As a liquid crystal composition forming a first optically-anisotropic layer, the following composition B-31 was prepared.

Composition B-31

| | |
|---|---|
| The above-described polyfunctional | 80.00 parts by mass |
| polymerizable liquid crystal compound A1-1 | |
| The above-described monofunctional | 20.00 parts by mass |
| polymerizable liquid crystal compound A2-4 | |
| The following chiral agent M-1 | 0.52 parts by mass |
| Polymerization initiator (IRGACURE- | 1.00 part by mass |
| OXE01, manufactured by BASF SE) | |
| The above-described leveling agent T-1 | 0.08 parts by mass |
| Methyl ethyl ketone | 1050.00 parts by mass |

### Chiral Agent M-1

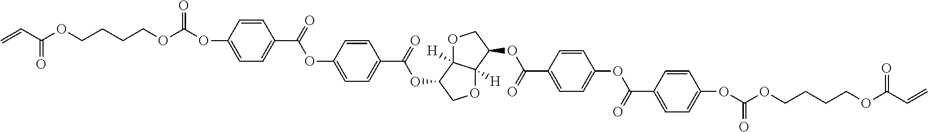 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

An optically-anisotropic layer was formed by applying multiple layers of the prepared composition B-31 to the alignment film P-1. A first optically-anisotropic layer according to Example 31 was formed using the same method as that of the first optically-anisotropic layer according to Example 1, except that the film thickness of the optically-anisotropic layer according to Example 1 was adjusted in the method of forming the optically-anisotropic layer.

Finally, in the first optically-anisotropic layer, Δn₅₅₀×thickness (Re(550)) of the liquid crystals was 150 nm, and it was verified using a polarization microscope that the periodically aligned surface was provided. In the liquid crystal alignment pattern of the optically-anisotropic layer, the single period over which the optical axis of the polymerizable liquid crystal compound rotated by 180° was 1.0 μm. In addition, in the optically-anisotropic layer, the twisted angle of the liquid crystal compound in the thickness direction was 114°.

Next, as a liquid crystal composition forming a second optically-anisotropic layer, the following composition B-32 was prepared.

Composition B-32

| | |
|---|---|
| The above-described polyfunctional | 80.00 parts by mass |
| polymerizable liquid crystal compound A1-1 | |
| The above-described monofunctional | 20.00 parts by mass |
| polymerizable liquid crystal compound A2-4 | |
| The above-described chiral agent M-1 | 0.16 parts by mass |
| Polymerization initiator (IRGACURE- | 1.00 part by mass |
| OXE01, manufactured by BASF SE) | |
| The above-described leveling agent T-1 | 0.08 parts by mass |
| Methyl ethyl ketone | 1050.00 parts by mass |

A second optically-anisotropic layer was formed using the same method as that of the first optically-anisotropic layer, except that the composition B-32 was used instead of the composition B-31 and the film thickness of the optically-anisotropic layer was adjusted.

Finally, in the second optically-anisotropic layer, Δn₅₅₀×thickness (Re(550)) of the liquid crystals was 335 nm, and it was verified using a polarization microscope that the periodically aligned surface was provided. In the liquid crystal alignment pattern of the optically-anisotropic layer, the single period over which the optical axis of the polymerizable liquid crystal compound rotated by 180° was 1.0 μm. In addition, in the optically-anisotropic layer, the twisted angle of the liquid crystal compound in the thickness direction was 85°.

Next, as a liquid crystal composition forming a third optically-anisotropic layer, the following composition B-33 was prepared.

Composition B-33

| | |
|---|---|
| The above-described polyfunctional | 80.00 parts by mass |
| polymerizable liquid crystal compound A1-1 | |
| The above-described monofunctional | 20.00 parts by mass |
| polymerizable liquid crystal compound A2-4 | |
| The following chiral agent H-1 | 0.29 parts by mass |
| Polymerization initiator (IRGACURE- | 1.10 part by mass |
| OXE01, manufactured by BASF SE) | |
| The above-described leveling agent T-1 | 0.08 parts by mass |
| Methyl ethyl ketone | 1050.00 parts by mass |

### Chiral Agent H-1

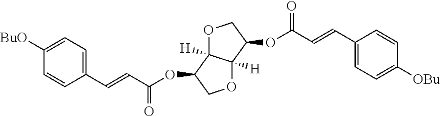

A third optically-anisotropic layer was formed using the same method as that of the first optically-anisotropic layer, except that the composition B-32 was used instead of the composition B-31 and the film thickness of the optically-anisotropic layer was adjusted.

Finally, in the third optically-anisotropic layer, Δn₅₅₀×thickness (Re(550)) of the liquid crystals was 170 nm, and it was verified using a polarization microscope that the periodically aligned surface was provided. In the liquid crystal alignment pattern of the optically-anisotropic layer, the single period over which the optical axis of the polymerizable liquid crystal compound rotated by 180° was 1.0 μm. In addition, in the optically-anisotropic layer, the twisted angle of the liquid crystal compound in the thickness direction was −41°.

### <Evaluation of Diffraction Efficiency>

In a case where light was incident into the prepared liquid crystal diffraction element from the front (direction with an angle of 0° with respect to the normal line), the diffraction efficiency of emitted light was evaluated.

Specifically, laser light components having output central wavelengths of 405 nm, 450 nm, 532 nm, and 650 nm were irradiated to be vertically incident into the prepared liquid crystal diffraction element from a light source. In the emitted light from the liquid crystal diffraction element, the intensities of diffracted light (first-order light) diffracted in a desired direction and zero-order light and negative first-order light emitted in the other directions were measured using a photodetector, and the diffraction efficiency at each of the wavelengths was calculated from the following expression. The zero-order light refers to light emitted in the same direction as that of incidence light. In addition, the negative first-order light refers to light diffracted in a −θ direction in a case where the diffraction angle of first-order light with respect to zero-order light was represented by θ.

Diffraction Efficiency=First-Order Light/(First-Order Light+Zero-Order Light+(Negative First-Order Light))

Regarding the irradiation of laser light into the prepared liquid crystal diffraction element, the laser light was vertically incident into a circularly polarizing plate corresponding to the wavelength of the laser light to be converted into circularly polarized light, and the circularly polarized light was incident.

It was found that, in liquid crystal diffraction element according to Example 31, a high diffraction efficiency was obtained at all the wavelengths.

### [Preparation of Circularly Polarizing Plate]

### <Preparation of Retardation Plate>

A film including a cellulose acylate film, an alignment film, and an optically-anisotropic layer C was obtained using the same method as a positive A plate described in paragraphs “0102” to “0126” of JP2019-215416A.

The optically-anisotropic layer C was the positive A plate (retardation plate), and the thickness of the positive A plate was controlled such that Re(550) was 138 nm.

The prepared retardation plate was bonded to a linearly polarizing plate through a pressure sensitive adhesive to prepare a circularly polarizing plate. The retardation plate and the linearly polarizing plate were disposed such that a relative angle between a slow axis of the retardation plate and an absorption axis of the linearly polarizing plate was 45°.

### <Preparation of Optical Element>

The prepared circularly polarizing plate was bonded to the liquid crystal diffraction element prepared in Example 31 to prepare an optical element. The optical element was prepared by disposing the liquid crystal diffraction element, the retardation plate, and the linearly polarizing plate in this order.

### [Evaluation]

In a case where light was incident into the prepared optical element from the front (direction with an angle of 0° with respect to the normal line), the intensity of emitted light was evaluated.

Specifically, laser light components having output central wavelengths of 405 nm, 450 nm, 532 nm, and 650 nm were irradiated to be vertically incident into the prepared optical element from a light source. In the emitted light from the liquid crystal diffraction element, the intensities of diffracted light (first-order light) diffracted in a desired direction and zero-order light emitted in the other directions were measured using a photodetector. Regarding the irradiation of laser light into the prepared optical element, the laser light was vertically incident into a circularly polarizing plate corresponding to the wavelength of the laser light to be converted into circularly polarized light, and the circularly polarized light was incident.

As a result, it was verified that, in the optical element where the circularly polarizing plate is bonded to the liquid crystal diffraction element prepared in Example 31, before bonding the circularly polarizing plate, the intensity of zero-order light at any wavelength can be significantly reduced, and the contrast ratio (intensity ratio first-order light/zero-order light) can be improved.

### <Change of Support>

Using a method described below, the support of the liquid crystal diffraction element can be appropriately changed depending on purposes. In addition, in the method described below, the thickness between the liquid crystal diffraction element and the changed support can be reduced, and the in-plane thickness of the liquid crystal diffraction element after changing the support can be made uniform with respect to, for example, a pressure sensitive adhesive (thickness: several micrometers to several tens of micrometers). This way, even in a case where the support of the liquid crystal diffraction element was changed, by making the in-plane thickness uniform, a direction of light emitted from the liquid crystal diffraction element can be accurately controlled in a plane.

The liquid crystal diffraction element and the new support may be laminated, for example, in the following procedure.

(1) A temporary support is bonded to the liquid crystal layer side of the support, the alignment film, and the liquid crystal diffraction element to be laminated. In this example, as the temporary support, MASTACK AS3-304 manufactured by Fujimori Kogyo Co., Ltd. was used.

(2) Next, the support and the alignment film present from the step of preparing the liquid crystal diffraction element are peeled off to expose the interface of the liquid crystal diffraction element on the alignment film side.

(3) A silicon oxide layer (SiOx layer) is formed on both of the interface of the liquid crystal diffraction element on the alignment film side and the interface of the newly prepared support. A method of forming the silicon oxide layer is not limited and, for example, vacuum deposition is preferably used. In this example, the formation of the silicon oxide layer was performed using a vapor deposition device (model number: ULEYES) manufactured by ULVAC, Inc. As a vapor deposition source, SiO₂ powder was used. The thickness of the silicon oxide layer is not limited and is preferably 50 nm or less. In this example, the thickness of the silicon oxide film was 50 nm or less.

(4) Next, plasma treatment is performed on both of the formed silicon oxide films, the formed silicon oxide layers are bonded to each other at 120° C., and the temporary support is peeled off.

Through the steps (1) to (4), a diffraction element where the liquid crystal diffraction element and the newly prepared support are laminated can be prepared. In addition, by changing the support to another liquid crystal diffraction element and repeating the steps (1) to (4), a diffraction element where two or three or more liquid crystal diffraction elements are laminated can be prepared.

Through the steps (1) to (4) the support of the liquid crystal diffraction element prepared in Example 1 was changed to a glass substrate having a thickness of 0.3 mm. As a comparison, using a pressure sensitive adhesive having a thickness of 25 μm, the support of the liquid crystal diffraction element prepared in Example 1 was changed to a glass substrate having a thickness of 0.3 mm (the liquid crystal diffraction element was bonded to the glass substrate through the pressure sensitive adhesive). In the liquid crystal diffraction element prepared through the steps (1) to (4), the in-plane thickness of the liquid crystal diffraction element was able to be made more uniform than that of the liquid crystal diffraction element prepared through the pressure sensitive adhesive.

### <Preparation of Laminate>

Likewise, a laminate including the liquid crystal diffraction element and another optical member or the like can be prepared.

For example, a laminate including a liquid crystal diffraction element, a retardation plate, and a polarizing plate was prepared using the following method.

A silicon oxide layer (SiOx layer) was formed on a liquid crystal layer side of a liquid crystal diffraction element including a support, an alignment film, and a liquid crystal layer to be laminated and on a bonding surface side of a retardation plate to be bonded to the liquid crystal diffraction element. A method of forming the silicon oxide layer is not limited and, for example, vacuum deposition is preferably used. In this example, the formation of the silicon oxide layer was performed using a vapor deposition device (model number: ULEYES) manufactured by ULVAC, Inc. As a vapor deposition source, SiO₂ powder was used. The thickness of the silicon oxide layer is not limited and is preferably 50 nm or less. In this example, the thickness of the silicon oxide film was 50 nm or less. Plasma treatment was performed on both of the formed silicon oxide films, and the formed silicon oxide layers were bonded to each other at 120° C. As a result, the laminate including the liquid crystal diffraction element and the retardation plate was formed. Likewise, by bonding a polarizing plate to the retardation plate and peeling off the support and the alignment film, a laminate consisting of the liquid crystal layer (liquid crystal diffraction element), the retardation plate, and the polarizing plate was prepared.

As the liquid crystal diffraction element, the liquid crystal diffraction element prepared in Example 31 was used. As the retardation plate, the retardation plate used for preparing the above-described circularly polarizing plate was used. As the polarizing plate, a laminate including each of the above-described linearly polarizing plate (polyvinyl alcohol layer type) and the absorptive polarizing plate was prepared.

It was verified that, in the optical element as the laminate including the liquid crystal diffraction element, the retardation plate, and the polarizing plate, before bonding the circularly polarizing plate (the laminate of the retardation plate and the polarizing plate), the intensity of zero-order light at any wavelength can be significantly reduced, and the contrast ratio (intensity ratio first-order light/zero-order light) can be improved.

### EXPLANATION OF REFERENCES

10: liquid crystal diffraction element
12: support
14: photo-alignment film
16, 34, 36: optically-anisotropic layer
18: coating film
30: polymerizable liquid crystal compound
30A: optical axis
60, 80: exposure device
62, 82: laser
64, 84: light source
68: beam splitter
70A, 70B, 90A, 90B: mirror
72A, 72B, 96: λ/4 plate
86, 94: polarization beam splitter
92: lens
Q1, Q2: absolute phase
E1, E2: equiphase surface

What is claimed is:

1. A liquid crystal diffraction element comprising:
an optically-anisotropic layer that is formed of a liquid crystal composition including a polymerizable liquid crystal compound,
wherein the polymerizable liquid crystal compound includes at least one monofunctional polymerizable liquid crystal compound having one polymerizable group,
the optically-anisotropic layer has a liquid crystal alignment pattern in which an orientation of an optical axis derived from the polymerizable liquid crystal compound changes while continuously rotating in at least one in-plane direction, and
in an infrared absorbance spectrum where a measurement sample obtained by powdering the optically-anisotropic layer is measured by Fourier transform infrared spectroscopy, in a case where an area of a peak having a maximum absorbance point in a range of 2200 cm⁻¹ to 2230 cm⁻¹ is represented by A (cm⁻¹), an area of a peak having a maximum absorbance point in a range of 1630 cm⁻¹ to 1640 cm⁻¹ is represented by B (cm⁻¹), and a mass of the measurement sample is represented by M (mg), both of Expressions (1) and (2) are satisfied,
$$A / M \geq 0.35 {cm}^{- 1} {mg}^{- 1} , and \qquad Expression ( 1 )$$
$$B / M \leq 0.55 {cm}^{- 1} {mg}^{- 1} . \qquad Expression ( 2 )$$

2. The liquid crystal diffraction element according to claim 1,
wherein the polymerizable liquid crystal compound further includes a polyfunctional polymerizable liquid crystal compound having two or more polymerizable groups.

3. The liquid crystal diffraction element according to claim 1,
wherein a content of the monofunctional polymerizable liquid crystal compound is 15% by mass or more with respect to a total mass of solid content of the liquid crystal composition.

4. The liquid crystal diffraction element according to claim 1,
wherein in an absorbance spectrum where a measurement sample obtained by powdering the optically-anisotropic layer is measured by Fourier transform infrared spectroscopy, in a case where an area of a peak having a maximum absorbance point in a range of 2200 cm⁻¹ to 2230 cm⁻¹ is represented by A (cm⁻¹) and a mass of the measurement sample is represented by M (mg), Expression (3) is satisfied,
$$A / M \geq 0.75 {cm}^{- 1} {mg}^{- 1} \qquad Expression ( 3 )$$

5. The liquid crystal diffraction element according to claim 1,
wherein the monofunctional polymerizable liquid crystal compound includes a compound represented by Formula (II), 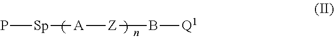
in Formula (II),
P represents a polymerizable group,
Q¹ represents a hydrogen atom, a halogen atom, —CN, —NCS, or an alkyl group having 1 to 15 carbon atoms, in a case where Q¹ represents an alkyl group having 1 to 15 carbon atoms, a hydrogen atom in the alkyl group may be substituted with a fluorine atom, and —CH₂-in the alkyl group may be substituted with —O—, —S—, —CQQ-, —SO—, —COO—, —OCO—, —CO—S—, —S—CO—, —O—CO—O—, —CO-NQ-, —NQ-CO—, —CQ=CQ-, —CQ=N—, —N═CQ-, —N═N—, —CQ=N—N═CQ-, or —C≡C—, Q represents a hydrogen atom, a fluorine atom, or an alkyl group having 1 to 10 carbon atoms, in a case where a plurality of Q's are present, the plurality of Q's may be the same as or different from each other,
Sp represents a single bond or a divalent linking group, Sp does not represent a divalent linking group having at least one group selected from the group consisting of an aromatic hydrocarbon ring group, an aromatic heterocyclic group, and an aliphatic hydrocarbon ring group,
n represents an integer of 1 to 5,
Z represents a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR=CR—, —CR=N—, —N═CR—, —N═N—, —CR=N—N═CR—, —CF=CF—, or —C≡C—, R represents a hydrogen atom or an alkyl group having 1 to 10 carbon atoms, in a case where a plurality of R's are present, the plurality of R's may be the same as or different from each other,
in a case where n represents 1, Z represents —C≡C—, and in a case where n represents an integer of 2 to 5, a plurality of Z's may be the same as or different from each other and at least one Z represents —C≡C—,
A and B each independently represent a 5-membered ring, a 6-membered ring, or a 7-membered ring, or a divalent cyclic group that may have a substituent and is formed by fusing the rings, and at least one of A or B represents a substituted or unsubstituted 1,4-phenylene group, A and B may be each independently substituted with a halogen atom, —CN, —NCS, or an alkyl group having 1 to 8 carbon atoms, in a case where A and B are substituted with an alkyl group having 1 to 8 carbon atoms, a hydrogen atom in the alkyl group may be substituted with a fluorine atom, and —CH₂— in the alkyl group may be substituted with —O—, —S—, —COO—, —SO—, —COO—, —OCO—, —CO—S—, —S—CO—, —O—CO—O—, —CO-NQ-, —NQ-CO—, —CQ=CQ-, —CQ=N—, —N═CQ-, —N═N—, —CQ=N—N═CQ-, or —C≡C—, Q represents a hydrogen atom, a fluorine atom, or an alkyl group having 1 to 5 carbon atoms, in a case where a plurality of Q's are present, the plurality of Q's may be the same as or different from each other, and in a case where n represents an integer of 2 to 5, a plurality of A's may be the same as or different from each other.

6. The liquid crystal diffraction element according to claim 1,
wherein the liquid crystal composition includes a chiral compound.

7. An optical element comprising:
the liquid crystal diffraction element according to claim 1; and
a circularly polarizing plate.

8. The optical element according to claim 7,
wherein the circularly polarizing plate includes a retardation plate and a polarizer, and
the liquid crystal diffraction element, the retardation plate, and the polarizer are provided in this order.

9. An optical element comprising, in the following order:
the liquid crystal diffraction element according to claim 1;
a silicon oxide layer; and
a support.

10. An optical element comprising:
the liquid crystal diffraction element according to claim 1; and
a phase modulation element.

11. The optical element according to claim 7, further comprising:
a phase modulation element.

12. An image display unit comprising:
the liquid crystal diffraction element according to claim 1.

13. A head-mounted display comprising:
the image display unit according to claim 12.

14. A beam steering comprising:
the liquid crystal diffraction element according to claim 1.

15. A sensor comprising:
the liquid crystal diffraction element according to claim 1.

16. The liquid crystal diffraction element according to claim 2,
wherein a content of the monofunctional polymerizable liquid crystal compound is 15% by mass or more with respect to a total mass of solid content of the liquid crystal composition.

17. The liquid crystal diffraction element according to claim 2,
wherein in an absorbance spectrum where a measurement sample obtained by powdering the optically-anisotropic layer is measured by Fourier transform infrared spectroscopy, in a case where an area of a peak having a maximum absorbance point in a range of 2200 cm⁻¹ to 2230 cm⁻¹ is represented by A (cm⁻¹) and a mass of the measurement sample is represented by M (mg), Expression (3) is satisfied,
$$A / M \geq 0.75 {cm}^{- 1} {mg}^{- 1} . \qquad Expression ( 3 )$$

18. The liquid crystal diffraction element according to claim 2,
wherein the monofunctional polymerizable liquid crystal compound includes a compound represented by Formula (II), 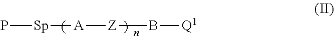
in Formula (II),
P represents a polymerizable group,
Q¹ represents a hydrogen atom, a halogen atom, —CN, —NCS, or an alkyl group having 1 to 15 carbon atoms, in a case where Q¹ represents an alkyl group having 1 to 15 carbon atoms, a hydrogen atom in the alkyl group may be substituted with a fluorine atom, and —CH₂-in the alkyl group may be substituted with —O—, —S—, —CQQ-, —SO—, —COO—, —OCO—, —CO—S—, —S—CO—, —O—CO—O—, —CO-NQ-, —NQ-CO—, —CQ=CQ-, —CQ=N—, —N═CQ-, —N═N—, —CQ=N—N═CQ-, or —C≡C—, Q represents a hydrogen atom, a fluorine atom, or an alkyl group having 1 to 10 carbon atoms, in a case where a plurality of Q's are present, the plurality of Q's may be the same as or different from each other,
Sp represents a single bond or a divalent linking group, Sp does not represent a divalent linking group having at least one group selected from the group consisting of an aromatic hydrocarbon ring group, an aromatic heterocyclic group, and an aliphatic hydrocarbon ring group,
n represents an integer of 1 to 5,
Z represents a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR=CR—, —CR=N—, —N═CR—, —N═N—, —CR=N—N═CR—, —CF=CF—, or —C≡C—, R represents a hydrogen atom or an alkyl group having 1 to 10 carbon atoms, in a case where a plurality of R's are present, the plurality of R's may be the same as or different from each other,
in a case where n represents 1, Z represents —C≡C—, and in a case where n represents an integer of 2 to 5, a plurality of Z's may be the same as or different from each other and at least one Z represents —C≡C—,
A and B each independently represent a 5-membered ring, a 6-membered ring, or a 7-membered ring, or a divalent cyclic group that may have a substituent and is formed by fusing the rings, and at least one of A or B represents a substituted or unsubstituted 1,4-phenylene group, A and B may be each independently substituted with a halogen atom, —CN, —NCS, or an alkyl group having 1 to 8 carbon atoms, in a case where A and B are substituted with an alkyl group having 1 to 8 carbon atoms, a hydrogen atom in the alkyl group may be substituted with a fluorine atom, and —CH₂— in the alkyl group may be substituted with —O—, —S—, —CQQ-, —SO—, —COO—, —OCO—, —CO—S—, —S—CO—, —O—CO—O—, —CO-NQ-, —NQ-CO—, —CQ=CQ-, —CQ=N—, —N═CQ-, —N═N—, —CQ=N—N═CQ-, or —C≡C—, Q represents a hydrogen atom, a fluorine atom, or an alkyl group having 1 to 5 carbon atoms, in a case where a plurality of Q's are present, the plurality of Q's may be the same as or different from each other, and in a case where n represents an integer of 2 to 5, a plurality of A's may be the same as or different from each other.

19. The liquid crystal diffraction element according to claim 2,
wherein the liquid crystal composition includes a chiral compound.

20. An optical element comprising:
the liquid crystal diffraction element according to claim 2; and
a circularly polarizing plate.
